(19) United States
(12) Patent Application Publication
(10) Pub. No.: US 2015/0088799 A1
(43) Pub. Date: Mar. 26, 2015

(54) INPUT ASSISTANCE DEVICE, INPUT ASSISTING METHOD, AND RECORDING MEDIUM STORING INPUT ASSISTANCE PROGRAM

(71) Applicant: NEC Corporation, Tokyo (JP)

(72) Inventors: Wenqi ZHOU, Tokyo (JP); Nobutatsu NAKAMURA, Tokyo (JP)

(21) Appl. No.: 14/496,218

(22) Filed: Sep. 25, 2014

(30) Foreign Application Priority Data
Sep. 25, 2013 (JP) 2013-197739

(51) Int. Cl. G06N 5/04; G06F 3/0481

(52) U.S. Cl. CPC G06N 5/048; G06F 3/04817
USPC 706/46

(57) ABSTRACT

An input assistance device according to an exemplary aspect of the present invention includes: an operation storing unit which stores a plurality of types of operations targeting a display object arranged in a shared screen shared by a plurality of terminal devices; an operation history storing unit which stores a history operation that is a performed operation targeting an arranged object which is the display object stored in display object storing unit and arranged in the shared screen, in order of performance of the history operation, and stores participating user identifiers that are identifiers of users of the plurality of terminal devices; and an operation score deriving unit which derives an operation probability being a probability that a target user performs next time a candidate operation being the operation stored in the operation storing unit, based on a target user identifier, the history operation, and the participating user identifier.

This application is based upon and claims the benefit of priority from Japanese Patent Application No. 2013-197739, filed on Sep. 25, 2013, the disclosure of which is incorporated herein in its entirety by reference.

### TECHNICAL FIELD

The present invention relates to a technology for estimate an operation performed by a user.

### BACKGROUND ART

As one of common methods on a conference, free discussion is known, in which participant's opinions are written on a whiteboard which all the participants can simultaneously read, and all the participants discuss while sharing the written opinions. In these days, speed of a communication network is increased, and consequently a communication conference using a PC (Personal Computer) is currently common. In a Web conference, which is one of the communication conferences, participants can perform information sharing and discussion using their individual PCs with electrical whiteboard application programs. The electrical whiteboard application program is an application program by which drawing can be performed separately from terminal devices on a shared screen, which is called an electrical whiteboard and is shared by the terminal devices that are communicably connected with one another via a communication network. The electrical whiteboard application program is also called a whiteboard tool. As smart devices (i.e. smart phones and tablet PCs) are widely used, increasingly more people share information and participate in a discussion during a trip by using smart phones or tablet PCs having the electrical whiteboard application programs.

When such whiteboard tool is used, it may be required to draw a figure and input a text quickly. A lot of icons and menus are required in order to enable a user to draw various kinds of figures and to set various kinds of formats on drawn figures and inputted texts. Therefore, it is a burden for a user to search a desired operation from a lot of icons and menus. Particularly in the whiteboard tool used in the smart device, the number of icons and menus which can be displayed is limited because a screen is small. In the whiteboard tool of the smart device, many pages or hierarchies are used for menus to input figures and texts and to set formats. Therefore, it is difficult to find icons or menus for desired operations. Selection thereof is troublesome.

Patent Literature 1 (Japanese Unexamined Patent Application No. 2004-152276) discloses an information terminal device which predicts an operation performed next to a specific operation inputted by a user on the basis of a history of the preset number of operations of the user. The information terminal device of Patent Literature 1 derives probability of an operation performed after an operation or a series of operations. The information terminal device of Patent Literature 1 selects the operation with the highest derived probability as a predicted operation i.e. an operation performed after the operation or the series of operations performed by the user. The information terminal device of Patent Literature 1 further executes processing to be executed when the user performs the predicted operation. The information terminal device of Patent Literature 1 compares the predicted operation with the operation performed next by the user, and informs the user when the compared operations are different. Patent Literature 1 also discloses the information terminal device which derives the probability for each time zone when operations are performed.

### SUMMARY

When the above-described whiteboard tools are used, users of terminals may perform operations targeting display objects, such as a text, a figure, and the like, arranged in the shared screen shared by the terminals. In such cases, probability that a user performs a specific operation after a series of operations in the shared screen by users may be different, even when the series of operations are the same, if a combination of other users performing operations in the shared screen is different. For example, in a conference in which user A who is not an expert participates, when a user inputs a figure, user B may input a text giving explanations of the figure to user A. In a conference in which user A does not participate, when a user input a figure, user B may perform a different operation, for example, an operation brushing up the figure. As described above, probability of an operation after a series of operations may differ if combination of other users differs.

The information terminal device of Patent Literature 1 calculates probability on the basis of a history of operations performed by the user of the information terminal device 1. The information terminal device of Patent Literature 1 cannot predict an operation after a series of operations with high accuracy when a plurality of users perform operations.

One of the objects of the present invention is to provide an input assistance device which is able to improve accuracy of an estimation of a user's operation which is performed next to a series of operations when a plurality of users perform operations in a shared screen.

### Means for Solving the Problem

An input assistance device according to an exemplary aspect of the present invention includes: an operation storing unit which stores a plurality of types of operations targeting a display object arranged in a shared screen shared by a plurality of terminal devices; an operation history storing unit which stores a history operation that is a performed operation targeting an arranged object which is the display object stored in display object storing unit and arranged in the shared screen, in order of performance of the history operation, and stores participating user identifiers that are identifiers of users of the plurality of terminal devices; and an operation score deriving unit which derives an operation probability being a probability that a target user who is a user of a target terminal device in the plurality of terminal devices performs next time a candidate operation being the operation stored in the operation storing unit, based on a target user identifier being an identifier of the target user, the history operation, and the participating user identifier.

An input assisting method according to an exemplary aspect of the present invention includes: storing a plurality of types of operations targeting a display object arranged in a shared screen shared by a plurality of terminal devices in operation storing unit; storing a history operation that is a performed operation targeting an arranged object that is the display object stored in display object storing unit and arranged in the shared screen, in order of performance of the history operation, and storing participating user identifiers that are identifiers of users of the plurality of terminal devices in an operation history storing unit; and deriving an operation probability being a probability that a target user who is a user of a target terminal device in the plurality of terminal devices performs next time a candidate operation being the operation stored in the operation storing unit, based on a target user identifier being an identifier of the target user, the history operation, and the participating user identifier.

A non-transitory computer-readable recording medium according to an exemplary aspect of the present invention stores an input assistance program causing a computer to operate as: operation storing unit which stores a plurality of types of operations targeting a display object arranged in a shared screen shared by a plurality of terminal devices; operation history storing unit which stores a history operation that is a performed operation targeting an arranged object that is the display object stored in display object storing unit and arranged in the shared screen, in order of performance of the history operation, and for storing participating user identifiers that are identifiers of users of the plurality of terminal devices; and operation score deriving unit which derives an operation probability being a probability that a target user who is a user of a target terminal device in the plurality of terminal devices performs next time a candidate operation being the operation stored in the operation storing unit, based on a target user identifier being an identifier of the target user, the history operation, and the participating user identifier.

### Effect of the Invention

The present invention has advantageous effect that accuracy of an estimation of a user's operation which is performed next to a series of operations when a plurality of users perform operations in a shared screen.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a structure of an input assistance device 1C of a second exemplary embodiment of the present invention,

FIG. 2 is a block diagram illustrating an example of a structure of an information processing system 100 of a first exemplary embodiment of the present invention,

FIG. 3 is a block diagram conceptually illustrating a total image of the information processing system 100 of the first exemplary embodiment,

FIG. 4 is a flowchart illustrating an example of processing at the time of learning of an input assistance device 1 of the first exemplary embodiment,

FIG. 5 is a flowchart illustrating an example of processing of the input assistance device 1 of the first exemplary embodiment when the input assistance device 1 receives an operation.

FIG. 6 is a block diagram illustrating a structure of a recommend server 1E which is an example of implementation the input assistance device 1 of the first exemplary embodiment.

FIG. 7 is a diagram conceptually illustrating a relationship between a characteristic vector and a characteristic vector set,

FIG. 8 is a diagram conceptually illustrating a time characteristic vector and the characteristic vector set composed of the time characteristic vectors,

FIG. 9 is a diagram conceptually illustrating a space characteristic vector and the characteristic vector set composed of the space characteristic vectors,

FIG. 10 is a diagram conceptually illustrating a user attribute characteristic vector and the characteristic vector set composed of the user attribute characteristic vectors,

FIG. 11 is a flowchart illustrating an example of processing of the recommend server 1E in a machine learning phase,

FIG. 12 is a flowchart illustrating an example of processing of the recommend server 1E in a recommend phase,

FIG. 13 is a diagram conceptually illustrating a data flow in learning and score calculation,

FIG. 14 is a diagram illustrating an example of a computer 1000 which can be used to realize an input assistance device 1, an input assistance device 1A, an input assistance device 1B, an input assistance device 1C, and the recommend server 1E,

FIG. 15 is a block diagram illustrating an example of a structure of a terminal device 2A of a first modification example of the first exemplary embodiment.

FIG. 16 is a block diagram conceptually illustrating a total image of an information processing system 100A of the first modification example of the first exemplary embodiment,

FIG. 17 is a block diagram illustrating an example of structures of an input assistance device 1B and a terminal device 2B of a second modification example of the first exemplary embodiment.

FIG. 18 is a block diagram conceptually illustrating a total image of the information processing system 100B of the second modification example of the first exemplary embodiment.

### EXEMPLARY EMBODIMENT

### First Exemplary Embodiment

A first exemplary embodiment of the present invention is explained in detail with reference to drawings.

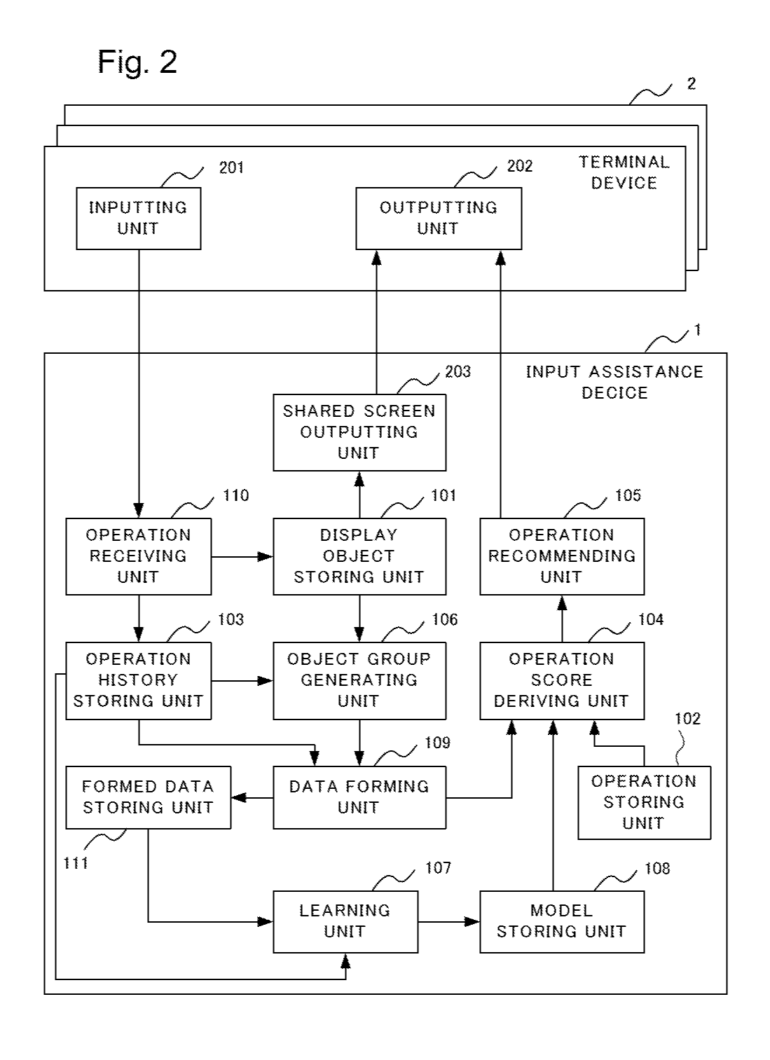

FIG. 2 is a block diagram illustrating an example of a structure of an information processing system 100 of the present invention exemplary embodiment.

With reference to FIG. 2, the information processing system 100 of the exemplary embodiment includes an input assistance device 1, a plurality of terminal devices 2. Each of the terminal devices 2 can communicate with the input assistance device 1.

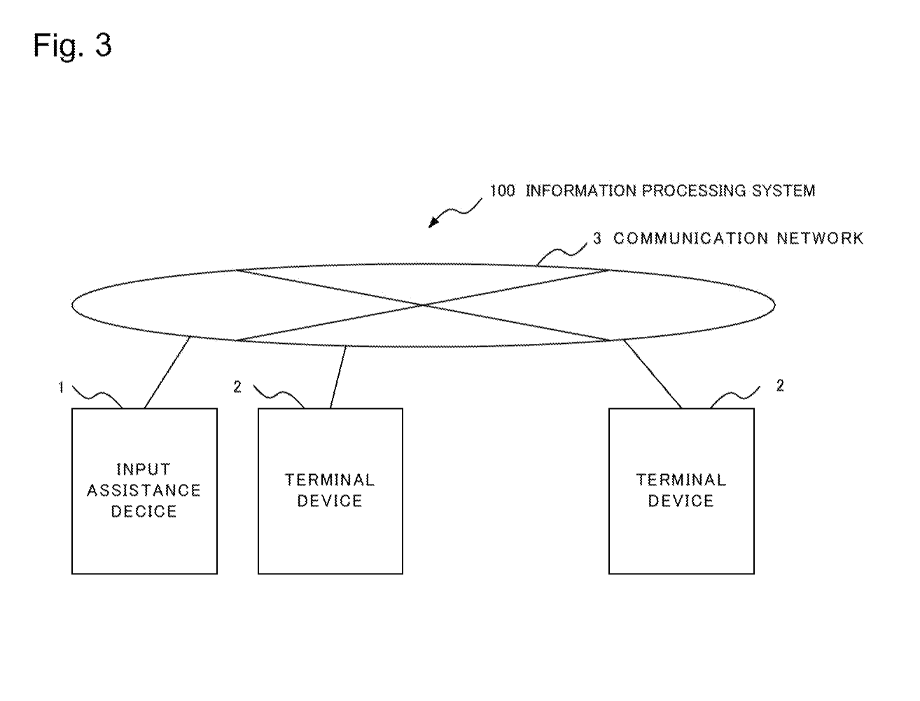

FIG. 3 is a block diagram conceptually illustrating a total image of the information processing system 100 of the present exemplary embodiment. With reference to FIG. 3, the input assistance device 1 and each of the terminal devices 2 are communicably connected via a communication network 3. The input assistance device 1 communicates with each of the terminal devices 2 through the communication network 3.

The input assistance device 1 shown in FIG. 2 includes a display object storing unit 101, an operation storing unit 102, an operation history storing unit 103, an operation score deriving unit 104, an operation recommending unit 105, an object group generating unit 106, a learning unit 107, a model storing unit 108, a data forming unit 109, an operation receiving unit 110, and a formed data storing unit 111. The input assistance device 1 may include a shared screen outputting unit 203. The input assistance device 1 may not include the shared screen outputting unit 203. If the input assistance device 1 does not include the shared screen outputting unit 203, another server device may include the shared screen outputting unit 203. The terminal device 2 includes an inputting unit 201 and an outputting unit 202.

The operation receiving unit 110 receives an operation by a user from the inputting unit 201 of the terminal device 2. The operation received by the operation receiving device 110 is, for example, an operation on the display object arranged in the shared screen. The shared screen is shared by each of the terminal device2 2. The display object is an object, e.g. a text, a figure, arranged in the shared screen. The operation on the display object is, for example, an operation to generate the display object, an operation to modify the display object. The operation on the display object is not limited the above operations and may be an operation by which a change occurs in at least any one of display objects arranged in the shared screen.

The operation receiving unit 110 receives, from the inputting unit 201, an operation ID (Identifier) which is an identifier representing a type of operations, and a display object ID which is an identifier of a display object which is a target of an operation. The operation receiving unit 110 may receive operation data including the operation ID and the display object ID. The operation receiving unit 110 may receive operation data including a state, after the operation, of the display object which is the target of the operation. The operation receiving unit 110 may receive an operation user identifier which is an identifier of the user performing the operation. The operation receiving unit 110 may store an identifier of a user of the terminal device 2 for each of the terminal devices 2. In this case, when receiving an operation from a terminal device 2, the operation receiving unit 110 may set the identifier of the user of the terminal device 2 as the operation user identifier. In descriptions of each exemplary embodiment of the inventions, data representing an operation performed by a user is described simply as “operation”. For example, receiving data representing an operation performed by a user is described as “receiving the operation”.

The operation receiving unit 110 may receive, from the inputting unit 201, an operation time in addition to an operation when the operation is performed. The operation receiving unit 110 may regard a time when the operation receiving unit 110 receives the operation as the operation time.

The operation receiving unit 110 receives the user IDs of all the terminal devices 2 sharing the shared screen from the terminal devices 2. The operation receiving unit 110 may acquire the user ID from the terminal device 2 when the terminal device 2 is connected to the input assistance device 1. The user of the terminal device 2 may input a user ID, which is received by the operation receiving unit 110, by using an inputting device (not illustrated) of the terminal device 2. The operation receiving unit 110 associates the received user ID with the identifier of the terminal device 2 which transmits the received user ID, and the operation receiving unit 110 stores the received user ID, for example, in the operation history storing unit 103.

The operation receiving unit 110 may store, in the operation history storing unit 103, the user IDs of the users of all the terminal devices 2 sharing the shared screen, for example, as a user list including the user IDs. The users of all the terminal devices 2 sharing the shared screen are the users who can use the shared screen. The operation receiving unit 110 may assign, to the user list, a user list ID which is an identifier to the user list. The operation receiving unit 110 may generate a new user list and store the new user list in the operation history storing unit 103, when a set of the users who can use the shared screen changes.

When a state of a terminal device 2 transfers to a state in which the terminal device 2 does not share the shared screen, the operation receiving unit 110 generates a user list in which the user ID associated with the identifier of the terminal device 2 is deleted from the user list stored in the operation history storing unit 103. The operation receiving unit 110 assigns a new user list ID to the generated user list. The operation receiving unit 110 stores the generated user list in the operation history storing unit 103. A user ID of a user of the terminal device 2 sharing the shared screen is referred to as a participating user ID tn the following description.

The display object storing unit 101 stores data representing a display object arranged in the shared screen. In the explanation of exemplary embodiments of the present invention, storing data representing a display object is described as storing the display object. The data representing a display object is data including an object ID of the display object, a type of the display objects, and contents of the display object. A display object stored in the display object storing unit 101 is associated with an arrangement position representing a position of the display object in the shared screen and a generation time when the display object is generated. The operation receiving unit 110 may associate the deleted display object, on which an operation of deleting is performed by a user, in the drawing objects stored in the display object storing unit 101, with a deletion time which is a time when the user deletes the deleted display object. The operation receiving unit 110 may remove the deleted display object from the display object storing unit 101.

The shared screen outputting unit 203 transmits the display object which is arranged in the shared screen stored in the display object storing unit 101 to the outputting unit 202 of each of the terminal devices 2. The shared screen outputting unit 202 may transmits, for example, object data representing a display object stored in the display object storing unit 101 to the outputting unit 202, as a display object. The object data is data including data representing an object ID of the display object, an arrangement position, and contents of the display object. The shared screen outputting unit 203 may generate shared screen data representing a shared screen on which the display object arranged on the basis of the display object stored in the display object storing unit 101. The shared screen data representing the shared screen is also described simply as “the shared screen” in the following description. The shared screen outputting unit 203 may transmit the generated shared screen (i.e. the generated shared screen data) to the outputting unit 202 of each of the terminal devices 2. If there is a display object associated with a deletion time, the shared screen outputting unit 203 eliminates the display object associated with the deletion time from the display objects arranged on the shared screen.

The operation receiving unit 110 applies the received operation to the display objects arranged in the shared screen. That is, the operation receiving unit 110 changes, according to the received operation, data representing the display object stored in the display object storing unit 101. If the received operation is an operation to generate a display object to be arranged in the shared screen, the operation receiving unit 110 associates the generation time with the display object. The operation receiving unit 110 may set an operation time of an operation generating a display object as a generation time of the display object. The operation receiving unit 110 may be designed so as to remove the display object from the display object storing unit 101 when the received operation is an operation to delete a display object which is arranged in the shared screen. The operation receiving unit 110 may be designed so as to associate the deletion time with the display object when the received operation is an operation which deletes a display object arranged in the shared screen. The operation receiving unit 110 may set the operation time of the operation deleting the display object as the deletion time of the display object.

The operation receiving unit 110 associates the received operation with the user performing the operation and the operation time of the operation. That is, the operation receiving unit 110 associates the operation ID representing the received operation with an identifier (i.e. a user ID) of the user performing the operation and the operation time of the operation. The operation receiving unit 110 stores the received operation, the user performing the operation and the operation time of the operation which are associated with each other in the operation history storing unit 103. That is, the operation receiving unit 110 may associates the operation ID of the received operation with the user ID of the user performing the operation and the operation time of the operation. The operation receiving unit 110 may store the operation ID of the received operation, the user ID of the user who performs the operation and the operation time of the operation, which are associated with one another, in the operation history storing unit 103. The operation receiving unit 110 further associates the received operation with a user list ID at the reception time of the operation.

The operation history storing unit 103 stores an operation received by the operation receiving unit 110. The operation history storing unit 103 may store an operation received by the operation receiving unit 110 in order of performance of the operations. The operation history storing unit 103 may store an operation received by the operation receiving unit 110 in order of reception of the operation by the operation receiving unit 110. In the explanation of the exemplary embodiments of the present invention, an operation stored by the operation history storing unit 103 is described as history operation. As described above, the operation history storing unit 103 stores the history operation which is associated with the user list ID. The operation history storing unit 103 may store the history operation which is associated with the user ID of the user who performs the history operation and the operation time of the history operation. In the explanation of the exemplary embodiments of the invention, data including the history operation, and the user ID and the operation time both associated with the history operation is described as history operation data. A group of history operations including one or more history operations is described as an operation history. The history operation included in the operation history may be sorted in order of the operation time of the history operation.

The operation history storing unit 103 further stores the user list.

The object group generating unit 106 generates an object group that is a group of display objects which are spatially and/or temporally close to the display object arranged in the shared screen.

The object group generating unit 106 generates the object group as follows. The object group generating unit 106 selects a display object as a determination target. The display object selected as the determination target by the object group generating unit 106 may be a newly generated object. The object group generating unit 106 determines whether following two conditions are satisfied or not between the selected display object and at least any one of display objects included in an object group in object groups.

The first condition is that a difference of the associated arranging positions is equal to or less than a preset distance (i.e. a distance threshold). The second condition is a difference of the associated generation times is equal to or less than a preset time threshold (i.e. a preset period of time).

If at least one of the conditions is satisfied, the object group generating unit 106 estimates that the selected display object is included in the object group. If the first condition is satisfied, the object group generating unit 106 may estimate that the selected display object is included in the object group. If the second condition is satisfied, the object group generating unit 106 may estimate that the selected display object is included in the object group.

The object group generating unit 106 may perform the above processing of estimation concerning the two conditions with respect to combinations of the selected display object and each of the existing object groups. If it is estimated that the selected display object is included simultaneously in two or more of the object groups, the object group generating unit 106 may merge the object groups simultaneously including the selected display object to generate one object group. If it is estimated that the selected display object is not included in any of the object groups, the object group generating unit 106 may generate a new object group including only the selected display object. In this case, the object group generating unit 106 may assign an object group ID to the generated object group. The object group generating unit 106 may associate the object ID of the display object included in the generated object group with the object group ID of the generated object group, and store the object ID associated with the object group ID, for example, in the display object storing unit 101.

The data forming unit 109 generates the operation history from the history operations stored in the operation history storing unit 103. The operation history is, for example, a group of one or more continuous history operations. The number of history operations included in one operation history may be set in advance. The data forming unit 109 may extract, from a plurality of continuous history operations, a plurality of operation histories each including history operations whose numbers are less than the number of the continuous history operations. The data forming unit 109 identifies the first operation after the last history operation included in the operation history and the user who performed the first operation. The data forming unit 109 may identify, in the continuous history operations, an operation which is associated with an operation time next to the latest operation time in the operation times associated with the history operations included in the operation history. When there is no history operation performed after the last history operation included in the operation history, the data forming unit 109 does not identify the first operation after the last history operation included in the operation history.

In the present exemplary embodiment, the data forming unit 109 generates an operation history which includes the history operations associated with the same user list ID and does not include the history operations associated with a user list ID other than the same user list ID. The data forming unit 109 initially classifies history operations stored in the operation history storing unit 103 into groups of history operations which include the same user list ID. The data forming unit 109 generates an operation history composed of history operations associated with the same user list ID for each of the user list IDs. The data forming unit 109 may identify the first operation performed after the history operation whose operation time is the latest in the operation times of the history operations associated with the same user list ID.

The data forming unit 109 may classify the history operations stored in the operation history storing unit 103 with respect to the object groups including the display object on which the history operations are performed. The data forming unit 109 may generate an operation history including the history operations on the display objects classified into the same object group for each of the object groups. The data forming unit 109 may identify the first operation performed after the history operation whose operation time is the latest in history operations on the display object classified into the same object group.

The data forming unit 109 generates, for each of the history operation included in the generated operation history, operation data in which the operation ID of the history operation is associated with user attribute characteristic data including the user ID of the user who performs the history operation. The data forming unit 109 generates, for the generated operation history, operation history data in which the operation data of the history operation included in the operation history is arranged in temporal order. The operation data of the history operation may be data in which the operation ID, user data, space characteristic data which is position data of the display object which is a target of the history operation, and time characteristic data representing a time when the history operation is performed are associated with one another. The user attribute characteristic data may include a group ID of the user. The time characteristic data may include the operation time of the history operation which is performed most recently in the operation history. The time characteristic data may include an elapsed time from the operation time of the first operation on the display object included in the object group. The space characteristic data may include coordinates of an arrangement position of the display object which is a target of the concerning operation. The space characteristic data may include a distance between an arrangement position of the display object which is a target of the operation which is performed most recently in the operation history and an arrangement position of the display object which is a target of the concerning operation. The space characteristic data may include an angle representing a direction of an arrangement position of the display object which is a target of the concerning operation with respect to an arrangement position of the display object which is a target of the operation which is performed most recently in the operation history.

The data forming unit 109 associates the generated operation history data with the user list ID which is associated with each of the history operation represented by the operation history data. The data forming unit 109 may add the user list identified by the user list ID to the operation history data.

The data forming unit 109 forms the operation history data into a form suitable for the operation score deriving unit 104 and the learning unit 107 described below. The form of data after forming may be fixed in advance. In the explanation of the exemplary embodiments of the invention, when the form of the data after forming is designed so as to be a data form in which one or more vectors representing characteristics are gathered, the data after forming may be described as a characteristics vector set. When data shaping is unnecessary, the data forming unit 109 does not perform forming of the form of data.

The data forming unit 109 stores the operation history data in the formed data storing unit 111. The data forming unit 109 may associate the operation history data to be stored in the formed data storing unit 111 with the first operation after the operation history represented by the operation history data. The data forming unit 109 may store the operation history data and the first operation after the operation history represented by the operation history data, which are associated with each other, in the formed data storing unit 111. The data forming unit 109 may associate the operation history data to be stored in the formed data storing unit 111 with the first operation after the operation history represented by the operation history data and the user ID of the user who performs the operation. The data forming unit 109 may store the operation history data, the first operation after the operation history represented by the operation history data, and the user ID of the user who performs the operation, which are associated with one another, in the formed data storing unit 111.

The data forming unit 109 store the operation history data in the formed data storing unit 111 for each of the object groups. The data forming unit 109 may associate the operation history data with the object group ID of the object group including the display object on which the history operation by which the operation history data is generated. The data forming unit 109 may store the operation history data and the object group ID, which are associated with each other, in the formed data storing unit 111. The data forming unit 109 may associate the operation history data with the first operation after the operation history represented by the operation history data. The data forming unit 109 may store the operation associated with the operation history data in the formed data storing unit 111 in addition to the operation history data. The data forming unit 109 may associate the operation history data with the first operation after the operation history represented by the operation history data and the user ID of the user who performs the operation. The data forming unit 109 may store, in addition to the operation history data, the operation and the user ID associated with the operation history data in the formed data storing unit 111.

The data forming unit 109 transmits the operation history data of the operation history including the latest operation received by the operation receiving unit 110 to the operation score deriving unit 104.

The formed data storing unit 111 stores, for each of the object groups, the operation history data associated with an operation. The operation associated with the operation history data is the operation which is performed first after the last operation included in the operation history represented by the operation history data.

The learning unit 107 derives a model to derive a score of a target operation i.e. an operation which is a target of score deriving by machine learning. The score derived using the model represents the degree of a likeliness that the target operation is an operation which is performed by a user after a series of operations are performed. Various existing supervised machine learning methods is able to be adopted as the method of the machine learning used by the learning unit 107. The learning unit 107 derives a model for each of the users of the terminal devices 2 which share the shared screen. When deriving a model on a user, the learning unit 107 reads, for example, operation history data associated with the operation of the user from the formed data storing unit 111. The operation history data associated with the operation of the user is operation history data which is associated with an operation ID and the user ID of the user. The learning unit 107 reads the user list identified by the user list ID associated with the operation history data, for example, from the operation history storing unit 103. If the operation history data is designed to include a user list, the learning unit 107 may not read the user list. The learning unit 107 derives a model for the user by performing the machine learning by using the read operation history data, the user list, the operation associated with the operation history data as supervised data. The data list used in the machine learning may be a user list in which the user list ID is associated with the operation history data. The used data list may be a user list included in the operation history data. The learning unit 107 may use, as the supervised data, the operation history data and the operation which are associated with the object group ID of the object group to which the display object that is the target of the latest operation received by the operation receiving unit 110 is classified.

The score of an operation is probability that the operation which is a target of score derivation is performed as an operation after the series of operations. The model is a parameter in an equation used for calculating the score from, for example, a value representing the series of operations and a value representing the operation which is the target of score calculation.

The learning unit 107 may derive the model for each of the users of the terminal devices 2 sharing the shared screen. The user IDs of the users of the terminal device 2 sharing the shared screen is stored, for example, in the operation history storing unit 103. The learning unit 107 reads, in series, one of the user IDs from the operation history storing unit 103. The learning unit 107 may derive the model on the basis of an operation performed by the user identified by the read user ID and a series of operations performed before the operation. The learning unit 107 may perform processing from selecting a user ID to deriving a model until all the user IDs stored in the operation history storing unit 103 are selected.

Learning algorithm of machine learning by which the learning unit 107 derives the model may be existing supervised machine learning algorithm. As such machine learning, for example, SVM (Support Vector Machine). Bayesian, Neural network, and SSI (Supervised Semantic Indexing) are known. SSI is described in “Supervised Semantic Indexing,” Bing Bai, Jason Weston, Ronan Collobert, David Grangier, Kunihiko Sadamasa, Yanjun Qi, Olivier Chapelle, Kilian Q. Weinberger, Conference: International Conference on Information and Knowledge Management—CIKM, pp. 761-765, 2009, which is referred to as Reference 1.

A model based on SSI is conceptually represented by multiplication of a vector representing the operation which is a target of score calculation and a matrix which is parameters representing the model, and a vector representing the series of operations. When performing learning using SSI, the learning unit 107 may derive the matrix which is the parameters by the method described in Reference 1.

When the operation receiving unit 110 receives an operation, the learning 107 may identify the object group including the display object which is a target of the operation. The learning unit 107 may generate the model on the basis of a series of operations including only operations on the display object included in the identified object group.

The learning unit 107 stores the derived model in the model storing unit 108. The learning unit 107 may associate the derived model with the user ID of the user whose model is derived. The learning unit 107 may store the model associated with the user ID in the model storing unit 108.

The model storing unit 108 stores the model which is derived by the learning unit 107 and is used for deriving the score of an operation as the operation which a user performs after a series of operations. The model storing unit 108 may store the model associated with the user ID of the user.

The operation storing unit 102 stores operations performed on the display objects. The operation IDs of operations designed as the operations performed on the display objects may be stored in advance. For example, a designer of the input assistance device 1 may store the operation IDs in the operation storing unit 102.

The operation score deriving unit 104 receives a plurality of continuous operations including the latest operation received by, for example, the operation receiving unit 110 and the user list associated with the operations, for example, from the operation history storing unit 103 through the data forming unit 109. The data forming unit 109 may generate the operation history data, for example, by transforming a plurality of continuous operations including the latest operation received by the operation receiving unit 110. The operation score deriving unit 104 may receive the operation history data and the user list associated with the operation history data from the data forming unit 109. Each of the operations in the plurality of continuous operations including the latest operation may be an operation targeting any one of the display object included in the object group which includes the display object targeted by the latest operation.

The operation score deriving unit 104 reads a model from the model storing unit 108. The operation score deriving unit 104 derives a score, using the read model and the received operation history data and user list, with respect to, for example, each of the operations stored in the operation storing unit 102. The operation score deriving unit 104 may select an operation which can be performed on the display object stored in the display object storing unit 101 from the operations stored in the operation storing unit 102. The operation score deriving unit 104 may derive the score with respect to the selected operation.

The operation score deriving unit 104 may perform processing from reading the model to deriving the score for all the users of the terminal devices 2 which are connected with the input assistance device 1 and shares the shared screen. As described above, the operation history storing unit 103 stores the user IDs of the users of the terminal devices 2 sharing the shared screen. The operation score deriving unit 104 may select one of the user IDs stored in the operation history storing unit 103. The operation score deriving unit 104 may read out the model associated with the read user ID from the model storing unit 108. The operation score deriving unit 104 may derive the score using the read model. The operation score deriving unit 104 may perform processing from reading the model to deriving the score until all of the user IDs stored in the operation history storing unit 103 are selected. When deriving the scores of all the operations stored in the operation storing unit 102 for the selected user ID, the operation score deriving unit 104 may associate transmit all the operation IDs and all the derived scores of the operation IDs with the selected user ID, and may transmit the operation IDs and the derived scores, which are associated with the selected user ID, to the operation recommending unit 105.

In the present exemplary embodiment, as described above, the score is a probability. In descriptions below, the score of an operation becomes higher, as the probability that the operation is an operation performed after a series of operations becomes higher.

The operation recommending unit 105 selects the preset number of the operations in descending order of the scores of the operations. The operation recommending unit 105 may select one or more of the operations. The number of operations selected by the operation recommending unit 105 may be selected, for example, by the input assistance device 1. The operation recommending unit 105 may select the operation whose score is higher than the prefixed score.

The operation recommending unit 105 sorts the selected operations in order of score. The operation recommending unit 105 outputs the list of operations sorted in order of score to inputting unit 201 of the terminal device 2.

The operation recommending unit 105 may perform processing from processing of selecting the operation to processing of transmitting the list of operations for all the users of the terminal devices 2 which are connected to the input assistance device 1 and shares the shared screen. When receiving the operation ID and the score calculated for the operation ID, which are associated with a user ID, the operation recommending unit 105 generates the list of the operations for each of the user IDs. The operation recommending unit 105 reads out an identifier of the terminal device 2 which is associated with each of the user IDs. The operation recommending unit 105 may output, to the terminal device 2 whose identifier is read out, the list of operations generated for the user ID which is associated with the terminal device 2.

The terminal device 2 includes the inputting device 201 and the outputting device 202, as described above.

The inputting unit 201 receives a signal representing a user's operation from an inputting device by which the user of the terminal device 2 inputs operations. The inputting device is not shown in FIG. 2. The inputting device is, for example, a keyboard, a mouse, or other pointing devices. The inputting device may be a display device with an inputting function, for example, a touch panel. The inputting device may be another device by which a user of the terminal device 2 is able to input operations. The inputting unit 201 determines whether or not the operation represented by the received signal is the operation on the display object arranged in the shared screen. If it is determined that the operation represented by the received signal is the operation on the display object arranged in the shared screen, the inputting unit 201 identifies the display object targeted by the operation and the type of the operation. The inputting unit 201 identifies details of the operation. The inputting unit 201 selects the operation ID representing the identified type of the operation. The inputting unit 201 transmits the selected operation ID and the object ID of the display object which is the operation target to the operation receiving unit 110. The inputting unit 201 may transmit the user ID of the user of the terminal device 2 including the inputting unit 201 as an operation user identifier to the operation receiving unit 110. The inputting unit 201 may transmit contents of the operation to the operation receiving unit 110. The inputting unit 201 may transmit operation data including the operation ID, the object ID, the object user identifier, and the details of the operation to the operation receiving unit 110.

The inputting unit 201 transmits the user ID of the user of the terminal device 2 including the inputting unit 201 to the operation receiving unit 110 when, for example, the terminal device 2 is connected to the input assistance device 1. The inputting unit 201 may transmit the user ID which the user inputs through the inputting device, which is not shown in FIG. 2. The inputting unit 201 may transmit the user ID stored in the terminal device 2 to the operation receiving unit 110.

The outputting unit 202 receives, from the shared screen outputting unit 203, the object data including, for example, the object ID of the display object, the arrangement position, data which represents details of the display object. The outputting unit 202 may generate a shared screen on the basis of the received object data. The outputting unit 202 receives, from the operation recommending unit 105, a list of operations which are sorted in descending order of score. The outputting unit generates a representation which recommends the user of the terminal device 2 to input the operation included in the list. The outputting unit 202 may receive the shared screen, for example, from the shared screen outputting unit 203 of the input assistance device 1. The outputting unit 202 may receive the representation which recommends the user to input the operation, for example, from the operation recommending unit 105 of the input assistance device 1. The outputting unit 202 displays the shared screen and the representation which recommends the user to input the operation, for example, on a display device (not illustrated) on which the terminal device 2 displays a screen. The representation which recommends the user to input the operation is, for example, an icon activating a function for inputting operations. The representation which recommends the user to input an operation may be a menu. In the description of the present exemplary embodiment, receiving data representing the representation which recommends the user to input an operation, such as an icon or a menu, is described as “receiving a representation recommending the user to input an operation” or the like. The outputting unit 202 may display the representation recommending the user to input an operation in the shared screen so that the representation overlaps with the shared screen. The outputting unit 202 may display the representation recommending the user to input an operation on the display device so that the representation does not overlap with an area where the shared screen is displayed. The display device of the terminal device 2 is not shown in FIG. 2, as described above. The display device is, for example, a flat panel display device. The display device may be the touch panel. The display device may be another device on which the terminal device 2 is able to display a screen.

An operation of an input assistance device 1A according to the present exemplary embodiment is explained in detail with reference to drawings.

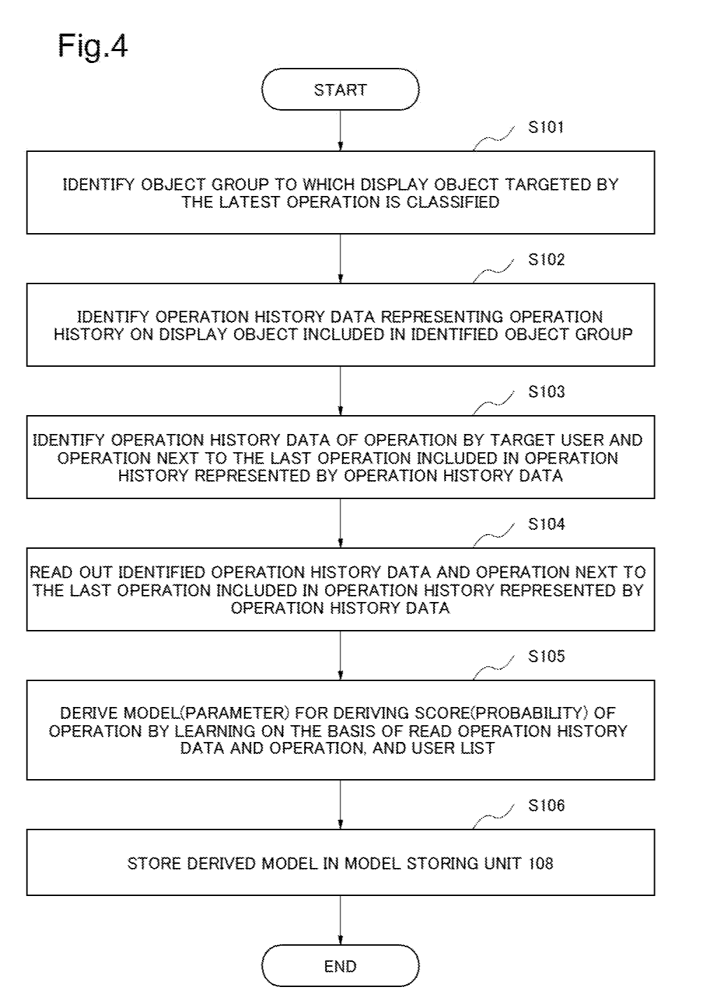

FIG. 4 is a flowchart illustrating an example of processing of an input assistance device 1 according to the present exemplary embodiment at the time of learning.

The learning unit 107 may start the processing shown in FIG. 4 when the operation receiving unit 110 newly receives an operation. In this case, for example, the operation receiving unit 110 may inform the learning unit 107 of new reception of the operation. The learning unit 107 may periodically start the processing shown in FIG. 4.

At the beginning of the action of FIG. 4, the object group is already generated. The operation history data is stored in the formed data storing unit 111. The operation history data is associated with the object group ID of each of the object groups, and includes operation data on a plurality of continuous operations. The operation history data is associated with the first operation which is performed after the last operation in a plurality of operations represented by the operation history data and the user ID of the user who performs the first operation.

The input assistance device 1 one by one selects a participating user ID in the participating user IDs stored in the operation history storing unit 103, and performs the processing shown in FIG. 4 for the selected participating user ID, until all the participating user IDs are selected. The participating user ID is a user ID of the user of the terminal device 2 sharing the shared screen. In the following, the selected participating user ID is referred to as a target user ID. The user identified by the selected participating user ID is referred to as a target user.

The learning unit 107 initially identifies an object group into which a display object targeted by the latest operation is classified (Step S101). The learning unit 107 may identify the latest operation, for example, on the basis of the operation times of the operations included in the operation history data. The learning unit 107 may identify the object group into which the display object targeted by the latest operation is classified by the object group ID associated with the operation history data including the latest operation.

The learning unit 107 identifies operation history data representing the operation history on the display object included in the identified object group (Step S102). The learning unit 107 may identify, for example, the operation history data which is associated with the object group ID of the identified object group.

The learning unit 107 identifies operation history data on operations performed by the target user, and an operation next to the last operation included in the operation history represented by the operation history data (Step S103). The learning unit 107 may identify operation history data which is associated with the target user ID from the operation history data identified in Step S102.

The learning unit 107 reads out the identified operation history data and the operation next to the last operation included in the operation history represented by the operation history data (Step S104). The learning unit 107 may read out the operation history data identified in Step S103 and the operation associated with the operation history data from the formed data storing unit 111.

The learning unit 107 derives the model for deriving an operation score by learning on the basis of the operation history data and operation which are read, and the user list (Step S105). As described above, the user list includes the user IDs of all the users of the terminal devices 2 sharing the shared screen. The learning unit 107 performs machine learning according to the learning method based on algorithm selected in advance by using the read operation history data and operations as supervised data. Thereby the learning unit 107 derives the model for deriving the score representing a probability that, when a series of operations and a target operation which is one of the operations are given, the target user performs the target operation after the series of operations. The model may be a parameter in an equation to derive the probability by using a value representing a series of operations and a value representing the target operation as arguments of a function in the equation. The equation may be given in advance.

Finally, the learning unit 107 stores the derived model in the model storing unit 108 (Step S106).

Next, processing of the input assistance device 1 when the input assistance device 1 receives an operation is described with reference to the drawings.

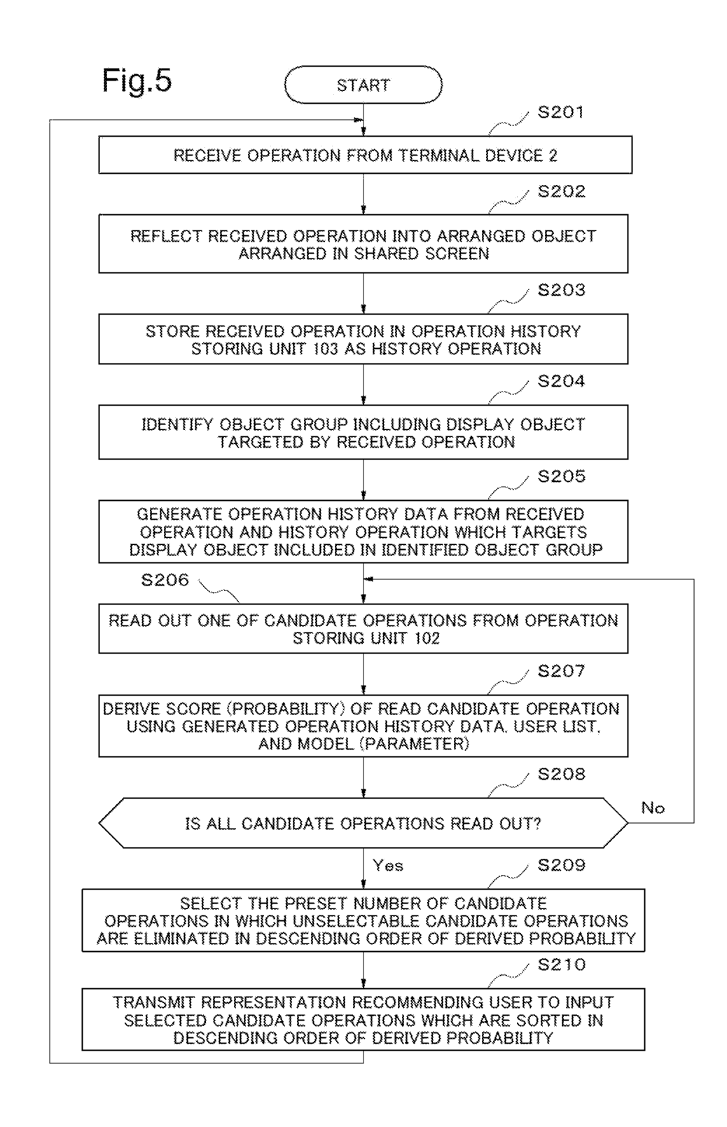

FIG. 5 is a flowchart illustrating an example of processing of the input assistance device 1 of the present exemplary embodiment when the input assistance device 1 receives an operation.

With reference to FIG. 5, the operation receiving unit 110 receives an operation from the terminal device 2 (Step S201). When receiving the operation, the operation receiving unit 110 may inform the learning unit 107 of receiving a new operation.

The operation receiving unit 110 applies the received operation on an arranged object which is a display object arranged in the shared screen (Step S202).

The operation receiving unit 110 stores the received operation in the operation history storing unit 103 as a history operation (Step S203).

The object group generating unit 106 identifies an object group including the display object targeted by the received operation (Step S204). When the received operation is generation of a display object, the display object is not included in any object group. In this case, if there is an already generated object group, the object group generating unit 106 estimates the object group into which the newly generated display object is classified. The object group generating unit 106 adds the newly generated object to the object group into which the display object is estimated to be classified. If the newly generated display object is estimated to be not included in any object group, the object group generating unit 106 generates a new object group including the newly generated display object.

Next, the data forming unit 109 generates operation history data from the history operations targeting display objects included in the object group identified in Step S201 and the received operation (Step S205). The data forming unit 109 may generate the operation history data from the received operation and the continuous history operations including the history operation performed just before the received operation. The number of operations which is used for generation of the operation history data may be set in advance. The data forming unit 109 transmits the operation history data generated in Step S205 to the operation score deriving unit 104.

The operation score deriving unit 104 may select one participating user ID from participating user IDs which is stored in the operation history storing unit 103 and is not selected. The operation score deriving unit 104 performs processing from Step S206 to Step S208 for the target user ID that is the selected participating user ID. Then the operation recommending unit 105 performs processing of Step S209 and Step S210. The operation assistance device 1 may repeat processing from Step S206 to Step S210 until the operation score deriving unit 104 selects all the participating user IDs.

The operation score deriving unit 104 initially reads out one candidate operation from candidate operations stored in the operation storing unit 102 (Step S206).

The operation score deriving unit 104 derives a score on a candidate operation by using the generated operation history data, the user list associated with the operation history data, and the generated model (Step S207). In the exemplary embodiment, the score derived in Step S207 is a probability that the target user performs the candidate operation after the series of operations represented by operation history data.

If at least one of the candidate operations are not read out from the operation storing unit 102 (No in Step S208), processing of the input assistance device 1 returns to Step S206.

If all the candidate operations are read out from the operation storing unit 102 (Yes in Step S208), the operation recommending unit 105 eliminates a candidate operation which is not able to be selected (i.e. unselectable) in a state after performance of the received operation. The operation recommending unit 105 selects the preset number of candidate operations in descending order of derived probability from remaining candidate operations (Step S209).

Next, the operation recommending unit 105 transmits, to the terminal device 2, a display recommending to input the selected candidate operations which are sorted in descending order of the derived probability (Step S210). The operation recommending unit 105 may transmit, to the terminal device 2, a list of the selected candidate operations which are sorted in descending order of the derived probability. The terminal device 2 may sort the representations recommending the user to input the candidate operations included in the list in order of sorted candidate operations, and may output the representations.

The exemplary embodiment described above has a first advantageous effect that accuracy of an estimate of a user's operation which is performed next to a series of operations is improved.

The first reason of the first effect is that the operation score deriving unit 104 calculates a probability of a user's operation which is performed next to a series of operations on the basis of the series of operations and users sharing the shared screen.

The second reason of the first effect is that the operation score deriving unit 104 calculates a probability that a user performs an operation next to a series of operations on the basis of the series of operations and user performing the series of operations.

Even if continuous operations are the same, when users performing the continuous operations are different, the operation which is performed after the continuous operations may be different. For example, there may be a case in which, after a user A successively inputs texts, the user A often makes up a rectangle. In that case, however, after the user A and a user B input a text, the user A often inputs a text successively. In such situation, if a next operation is predicted without using information on the users performing the operations, estimation with high accuracy cannot be expected. The operation score deriving unit 104 calculates a probability that an operation is performed next on the basis of the users who performed the operations. The input assistance device 1 of the exemplary embodiment can improve accuracy of estimation of an operation which a user performs next to a series of operations when a plurality of users perform the operations in the shared screen.

The present exemplary embodiment has the second advantageous effect that accuracy of estimation of an operation which a user performs next to a series of operations can be improved when an operation is performed in the shared screen where a plurality of display objects are arranged.

The first reason of the second advantageous effect is that the operation score deriving unit 104 estimates an operation which the user performs next to a series of operations on the basis of the series of operations and a position of the display object which is the target of each of the operations.

The second reason of the second advantageous effect is that the operation score deriving unit 104 estimates an operation which a user performs next to a series of operations on the basis of the series of operations and a time when each of the operations is performed.

Depending on a positional relationship between two objects generated by successive two operations, the next operation may vary. For example, there may be a case where, when a user generates a rectangle as a display object and successively inputs a text in the rectangle, the user often input a rectangle next. And in that case, however, when the user generates a rectangle as a display object and successively inputs a text under the rectangle, the user often input an arrow next. In such situation, if estimation of the next operation is performed without using the positional relationship of the objects generated by the two successive operations, high estimation accuracy cannot be expected. The operation score deriving unit 104 of the present exemplary embodiment uses the positional relationship between objects generated by, for example, the two successive operations and calculates probability that an operation is performed next. When an operation on the shared screen where a plurality of objects are arranged is performed, the input assistance device 1 of the present exemplary embodiment can improve accuracy of estimation of an operation which a user performs next to a series of operations.

(Example of Implementation)

An example of implementation based on the first exemplary embodiment of the invention is explained in detail with reference to drawings.

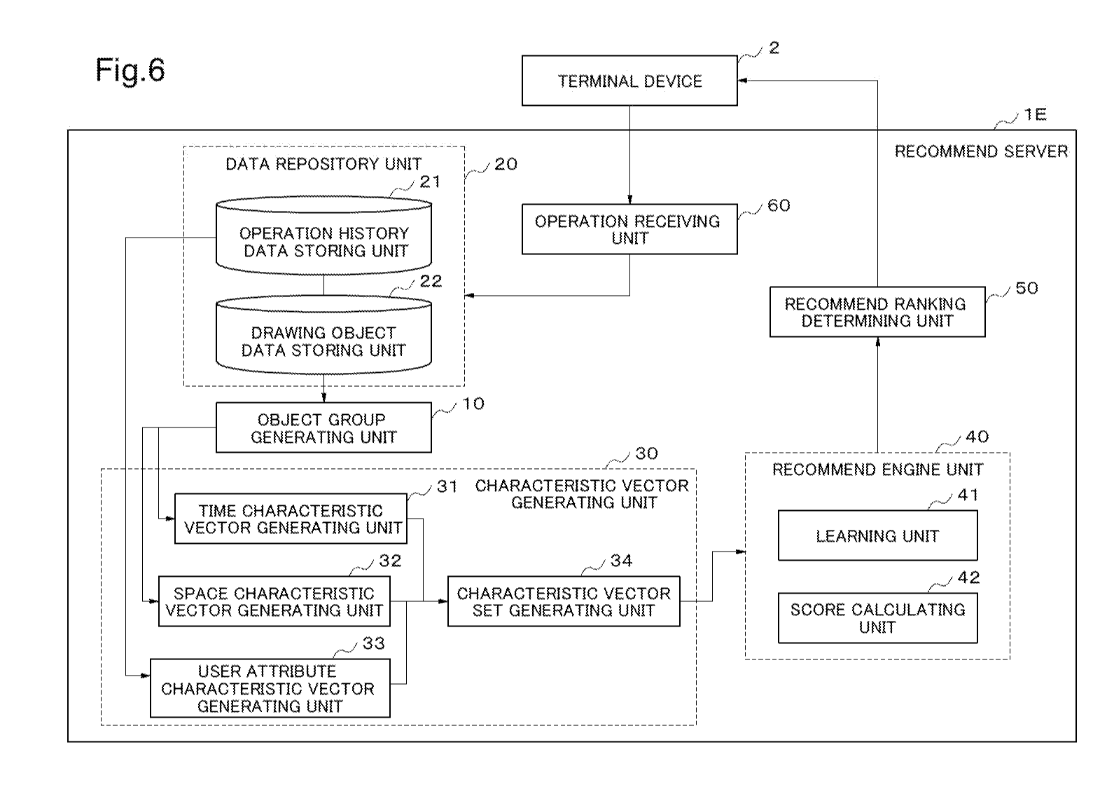

FIG. 6 is a block diagram illustrating a structure of a recommend server 1E according to an example of implementation of the input assistance device 1 of the first exemplary embodiment.

With reference to FIG. 6, the recommend server 1E includes an object group generating unit 10, a data repository unit 20, a characteristic vector generating unit 30, a recommend engine unit 40, a recommend ranking determining unit 50, and an operation receiving unit 60.

The data repository unit 20 includes an operation history data storing unit 21, and an object data storing unit 22.

The characteristic vector generating unit 30 includes a time characteristic vector generating unit 31, a space characteristic vector generating unit 32, a user attribute characteristic vector generating unit 33, and a characteristic vector set generating unit 34.

The recommend engine unit 40 includes a learning unit 41 and a score calculating unit 42.

A relationship between the elements of the recommend server 1E and the elements of the input assistance device 1 is described below.

The object group generating unit 10 corresponds to the object group generating unit 106. The operation history data storing unit 21 corresponds to the operation history storing unit 103. The object data storing unit 22 corresponds to the display object storing unit 101. The characteristic vector generating unit 30 corresponds to the data forming unit 109. The learning unit 41 corresponds to the learning unit 107. The score calculating unit 42 corresponds to the operation score deriving unit 104. The recommend ranking determining unit 50 corresponds to the operation recommending unit 105. The operation receiving unit 60 corresponds to the operation receiving unit 110 of the input assistance device 1. The data repository unit 20 works as the operation storing unit 102.

The structure of the recommend server 1E is described more specifically.

The operation receiving unit 60 receives operation of users. The data repository unit 20 includes the operation history data storing unit 21 storing operation history data of the users and the object data storing unit 22 storing data of registered objects. The object group generating unit 10 performs grouping of objects on the basis of spatial distances of the registered objects and/or temporal distance of operation times in an operation history. The characteristic vector generating unit 30 transforms the object group into a characteristic vector. The recommend engine unit 40 calculates an output probability (i.e. a probability for outputting) of a next operation candidate (i.e. a candidate of a next operation) on the basis of temporal relationship and spatial relationship in the object group, and the characteristic vector set representing a user attribute (i.e. an attribute of a user). The recommend ranking determining unit 50 eliminates an operation which is not able to be selected as a next operation candidate, and generates a recommend list in which operation candidates (i.e. operations that is able to be performed) are sorted in descending order of the output probability calculated by the recommend engine unit 40.

The characteristic vector generating unit 30 includes the time characteristic vector generating unit 31, the space characteristic vector generating unit 32, the user attribute characteristic vector generating unit 33, and the characteristic vector set generating unit 34. The time characteristic vector generating unit 31 generates, from an operation history, a time characteristic vector representing temporal relationship in the operation history. The space characteristic vector generating unit 32 generates a space characteristic vector representing spatial relationship between objects. The user attribute characteristic vector generating unit 33 generates a user attribute characteristic vector representing user attributes of the user who performs operations. The characteristic vector set generating unit 34 generates a characteristic vector set on the basis of the time characteristic vector, the space characteristic vector, and the user attribute characteristic vector.

The recommend engine unit 40 includes the learning unit 41 and a score calculating unit 42. The learning unit 41 performs learning on the basis of patterns each of which represents relation between the characteristic vector set and an operation. When a characteristic vector is given, the score calculating unit 42 calculates a probability of occurrence of an operation by using the characteristic vector and the result of learning.

The time relationship is an order of operations. The time relationship is represented by sorted order of the characteristic vectors representing operation information in the characteristic vector set described below. In the characteristic vector set, the characteristic vectors are sorted in order of performed time of the operations represented by the characteristic vectors.

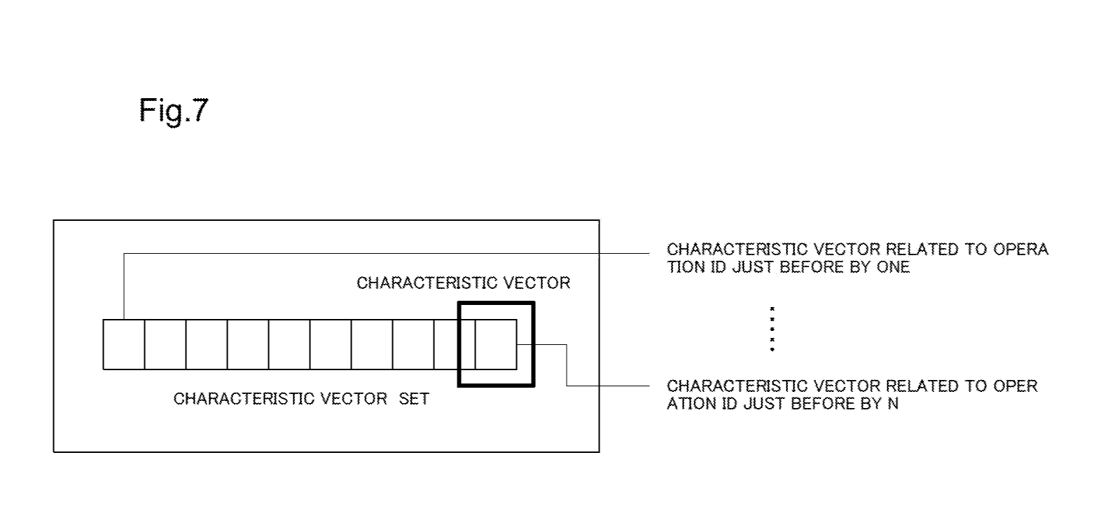

FIG. 7 is a diagram conceptually illustrating a relationship between the characteristic vector and the characteristic vector set. The characteristic vector set includes the characteristic vectors which are sorted in order of the performed time of the operations represented by the characteristic vectors. The characteristic vector includes the time characteristic vector, the space characteristic vector, and the user attribute characteristic vector. The time characteristic vector corresponds to the above-mentioned time characteristic data. The space characteristic vector corresponds to the above-mentioned space characteristic data. The user attribute characteristic vector corresponds to the above-mentioned user attribute characteristic data.

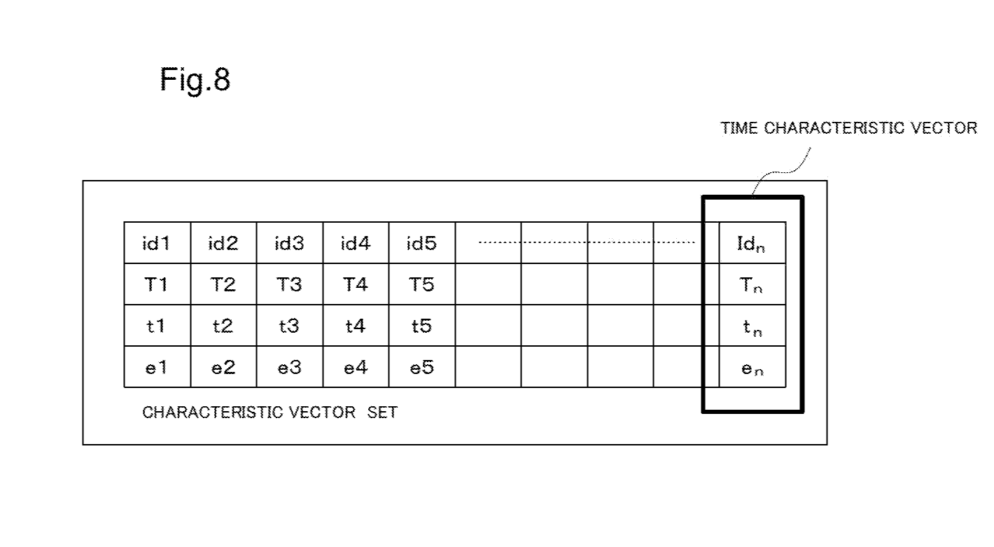

FIG. 8 is a diagram conceptually illustrating the time characteristic vector and the characteristic vector set generated by using the time characteristic vectors. The time characteristic vector is a vector representing the above-mentioned time relationship.

The time characteristic vector includes, for example, an operation ID which is an identifier of an operation and, a time when the operation is performed. For example, the operation ID of the leftmost vector in FIG. 8 is id1. In the leftmost vector, the time when the operation is performed is TI. By using a numerical value to represent time, it is possible to perform weighting on the operations depending on the time when the operations are performed. The time characteristic vector may include time difference i.e. difference between a time when the concerning operation, whose operation ID is included in the time characteristic vector, is performed and a time when an operation just before the concerning operation is performed. In the leftmost vector in FIG. 8, the value of the time difference is t1. By using time difference represented by a numerical value, it is possible to perform weighting on the operations depending on intervals of the operations. The time characteristic vector may include elapsed time, which is a period of time elapsed since a series of operations on the shared screen is started, at the time when the concerning operation is performed. For example, in the leftmost vector in FIG. 8, the value representing the elapsed time is el. By using a numerical value representing the elapsed time, it is possible to perform weighting on the operations depending on the elapsed time at the time when the operation is performed. In this case, the recommend server 1E can output various recommend operation lists which differ depending on the elapsed time.

The spatial relationship includes, for example, coordinates of a plural-operation object on a whiteboard. The whiteboard is the above-mentioned electrical whiteboard. In the explanation of the present example, the whiteboard means the electrical whiteboard. The whiteboard corresponds to the above-mentioned shared screen. The plural-operation objects is a display object on which a plurality of users is able to operate. In the explanation of the present example, the plural-operation object may be described simply as an object. The coordinates of the plural-operation object is represented by using two-dimensional coordinates represented by a combination of an x-coordinate value and a y-coordinate value.

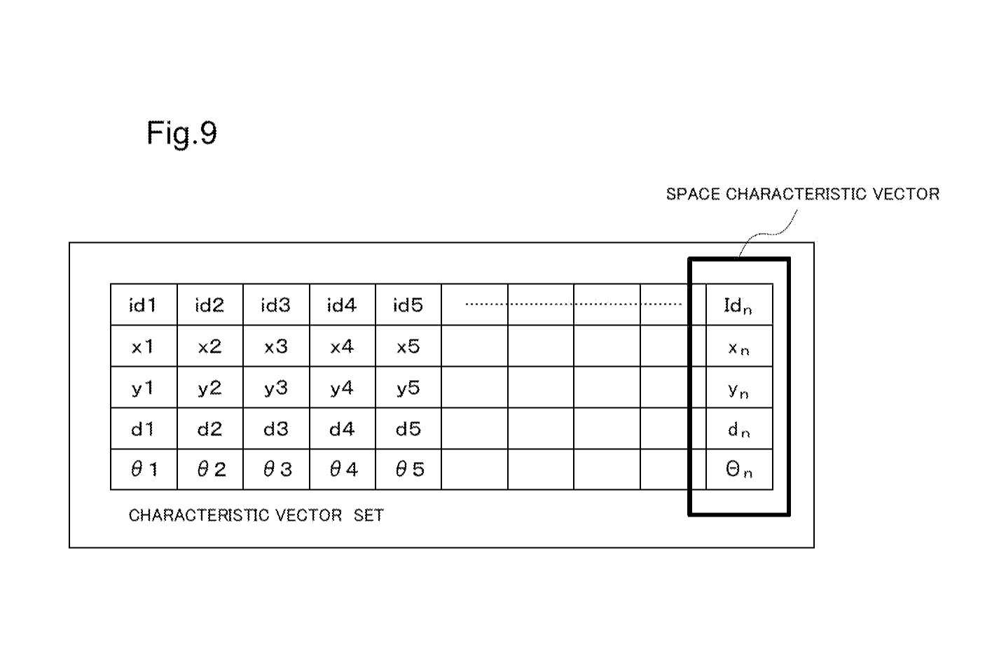

FIG. 9 is a diagram conceptually illustrating a space characteristic vector and the characteristic vector set generated by using the space characteristic vectors. The space characteristic vector is a vector representing the above mentioned spatial relationship.

The space characteristic vector includes, for example, an operation ID identifying an operation which is a target of the operation and coordinates of the object. The space characteristic vector shown in FIG. 9 includes an x-coordinate and a y-coordinate, as the coordinates. In the leftmost space characteristic vector in FIG. 9, the operation ID is id1, the x-coordinate is x1, and the y-coordinate is y1. By using numerical values representing the coordinates, it is possible to perform weighting on the operations depending on the positions of the objects on which the operations are performed. In this case, the recommend server 1E can output a recommend operation list which varies depending on a position where an operation is performed. In this case, the recommend server 1E is able to operate so as to output an itemized menu when a text box is generated at the upper left, and to output a menu making fonts smaller when a text box is generated at the lower side.

The space characteristic vector may include a distance between a position of an object on which the concerning operation, which is the operation whose operation ID is included in the space characteristic vector, is performed and a position of an object on which an operation just before the concerning operation is performed. For example, in the leftmost space characteristic vector in FIG. 8, the distance is d1. By using a numerical value representing a distance, it is possible to output the recommend list depending on the distance between the objects on which successive operations are performed. For example, when two rectangles are drawn successively, the two rectangles are the targets of the successive operations. The recommend server is able to operate so as to output a menu for changing a layer if these two rectangles are overlapped, and to output a menu for drawing an arrow if the distance between these two rectangles is large. The coordinates and the distance included in the space characteristic vector may be normalized according to a height and a width of the whiteboard. Normalizing is, for example, processing in which a coordinate value in the height direction is divided by the height of the whiteboard and a coordinate value in the width direction is divided by the width of the whiteboard.

The space characteristic vector may further include a value representing the direction to the position of the object on which the concerning operation is performed from the position of the object on which an operation just before the concerning operation is performed. The direction may be represented by an angle from any one of the coordinate axes. For example, in the leftmost space vector in FIG. 8, the angle is θ1. Many figures are drawn from left to right and/or from top to bottom. By using a value of the direction, the recommend list can be outputted depending on drawing order.

The user attribute is a list of the user IDs of the user performing an operations or a list of the user IDs of the users using the whiteboard.

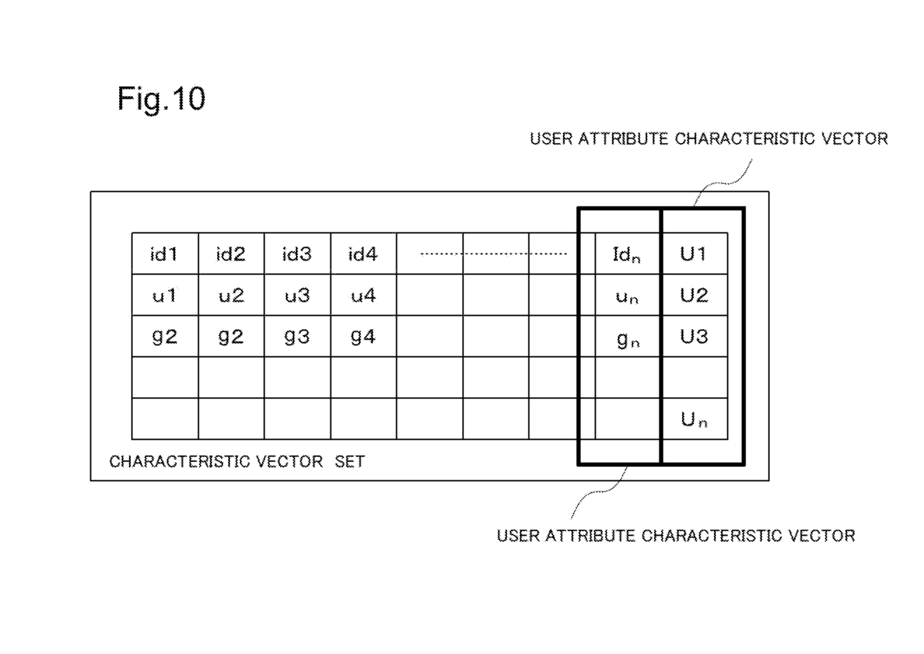

FIG. 10 is a diagram conceptually illustrating a user attribute characteristic vector and the characteristic vector set generated from the user attribute characteristic vectors.

One of the user attribute characteristic vectors is the list of user IDs of users using the whiteboard. In an example shown in FIG. 10, the rightmost user attribute characteristic vector is the user attribute characteristic vector representing the list of the user IDs of the users using the whiteboard. In the rightmost vector, U1 to Un is user IDs of users using a whiteboard. By using values of the user IDs, included in the list, of users using a whiteboard, it is possible to output the recommend list depending on the users of the whiteboard.

The user attribute characteristic vector may be a vector representing a user ID of a user performing at least one of the operations. In the example shown in FIG. 10, for example, the leftmost vector is a vector representing that the user whose user ID is u1 performs the operation whose operation ID is id1. The value of u1 in the leftmost vector may be any one of values from U1 to Un, which are values of elements of the rightmost vector. The user attribute characteristic vector may include a group ID of a group to which the user belongs. In the leftmost vector shown in FIG. 10, the group ID is g1. By using a value of the user ID of a user performing at least one of the operations, it is possible to output the recommend list depending on a pattern of operations of each of the users.

Next, processing of the recommend server 1E of the present example is described in detail with reference to drawings. Processing of the recommend server 1E of the present example is separated to a machine learning phase and a recommend phase of an operation.

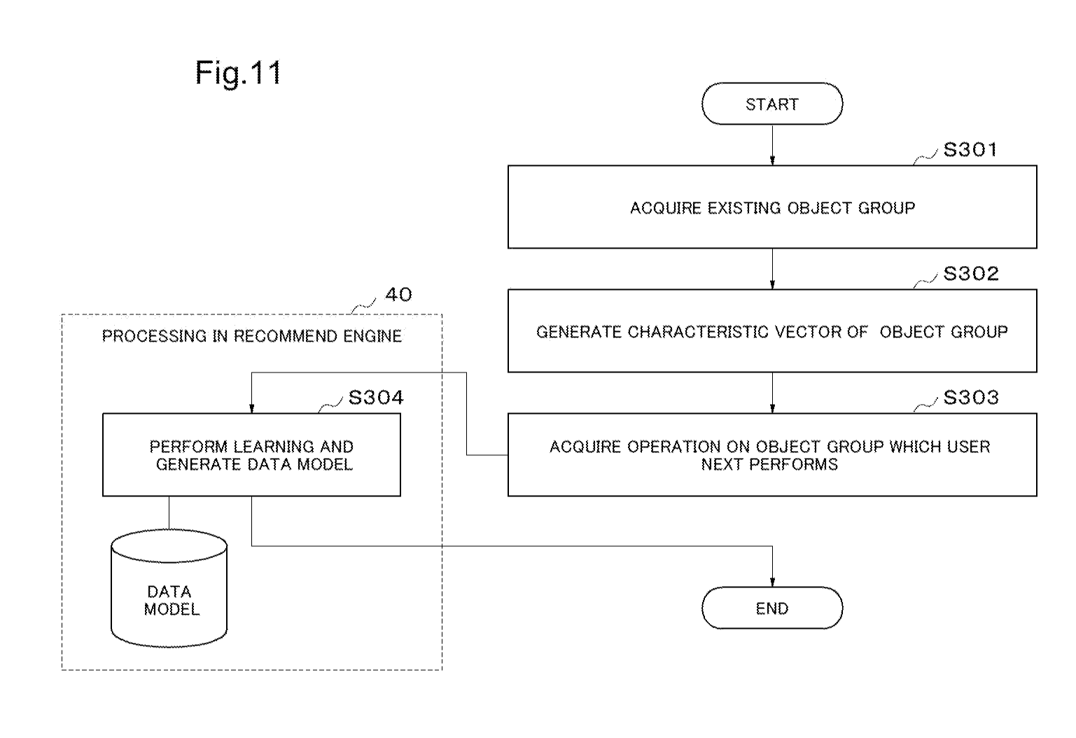

FIG. 11 is a flowchart illustrating an example of processing of the recommend server 1E in a machine learning phase.

The object group generating unit 10 acquires an existing object group from the data repository unit 20 (Step S301).

Next, the characteristic vector generating unit 30 generates a characteristic vector set of the object group (Step S302). In Step S302, the time characteristic vector generating unit 31 transforms a temporal relationship in the operation history of the operations performed on the object group into a vector. The space characteristic vector generating unit 32 transforms a spatial relationship in the objects included in the object group by using the operation history into a vector. The user attribute characteristic vector generating unit 33 transforms the user attributes in the object operation history into a vector. The characteristic vector set generating unit 34 transforms the vectors generated by the time characteristic vector generating unit 31, the space characteristic vector generating unit 32 and the user attribute characteristic vector generating unit 33 into a characteristic vector set.

The recommend engine unit 40 acquires the characteristic vector set generated by the characteristic vector set generating unit 34.

The recommend engine unit 40 acquires the next operation performed on the object group from the operation history data storing unit 21 included in the data repository unit 20 (Step S303). The recommended engine unit 40 may acquire a next operation i.e. the operation next to the series of operations of the operation history by which the characteristic vector set is generated, and the user ID of the user who perform the next operation.

The characteristic vector generating unit 30 (i.e. the time characteristic vector generating unit 31, the space characteristic vector generating unit 33 and the user attribute characteristic vector generating unit 33) may extracts operation histories, each of which includes a prefixed number of successive operations, from the entire operation history on the object group. The characteristic vector set generating unit 34 may generate the characteristic vector set by using the vectors generated from each of the extracted operation histories. The recommend engine unit 40 may acquire the operation next to each of the extracted operation histories in the entire operation history. The object group generating unit 10 may repeat Step S301. The characteristic vector set generating unit 30 may repeat Step S302. The recommend engine unit 40 may repeat Step S303. Then, as a result, many sets of the characteristic vector, the next operation and the user ID are obtained.

Next, the recommend engine unit 40 performs machine learning to generate a data model on the basis of the acquired characteristic vector set, the next operation and the user ID of the user who perform the next operation (Step S304). The data model corresponds to the model in the descriptions of the first exemplary embodiment.

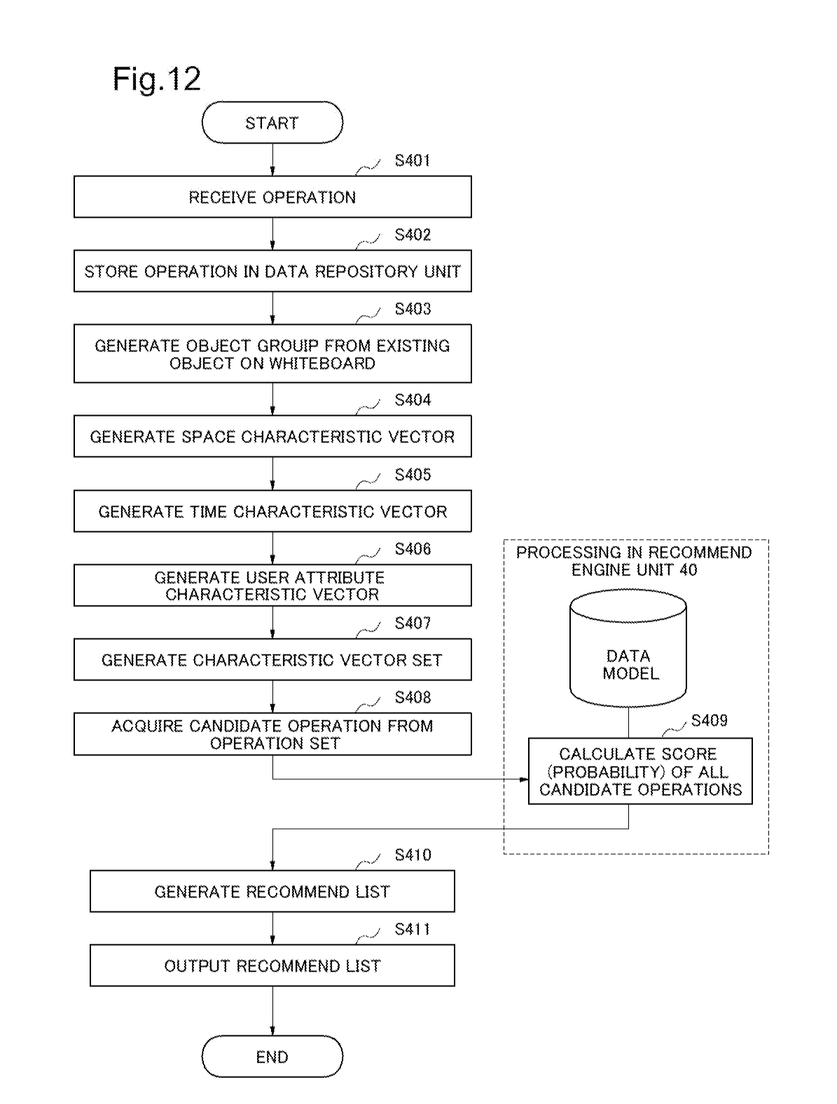

FIG. 12 is a flowchart illustrating an example of processing of the recommend server 1E in a recommend phase.

The operation receiving unit 60 receives an operation by a user on the whiteboard (Step S401).

The operation receiving unit 60 stores the received operation in the data repository unit 20 (Step S402).

Next, the object group generating unit 10 acquires information on all the objects on the whiteboard from the data depository unit 20. The object group generating unit 10 generates an object group from the acquired information on the objects (Step S403). The object group generating unit 10 stores the generated object group in the data repository unit 20.

The object is a graphic element, such as, a rectangle frame, a text, an arrow, or an image, on the whiteboard. The operation on an object is, for example, making the object on the whiteboard, setting an attribute, such as a color or a style, or setting a font or a character size. Operations on objects which are not relevant to each other are able to be assumed not to have any relationship one another. The object group generating unit 10 estimates that objects which are not relevant to each other belong to different operation histories. Two objects which are relevant to each other are objects which satisfy, for example, following two conditions. Two objects which are not relevant to each other are objects which do not satisfy, for example, following two conditions. The first condition is that the distance between positions where the two objects are located is within a position threshold value. The second condition is that a difference of time when the two objects are generated is within a time threshold value. When an object which is a target of an operation is relevant to at least one object in an object group, the operation is described as being relevant to the object group.

The object generating unit 10 determines whether or not the operation stored in Step S402 is relevant to any of an existing object group. If the operation stored in Step S402 is relevant to any of an existing object group, the object generating unit 10 adds the operation to the object group which is estimated to be relevant to the operation. If the operation is not relevant to any existing object group, the object generating unit 10 generates new object group. If the operation is relevant to a plurality of existing object groups, the object generating unit 10 merges the plurality of existing object groups to one object group.

The time characteristic vector generating unit 31 generates a vector (i.e. a time characteristic vector) by transforming temporal relationship in the operation history of the existing object group which is relevant to the operation into the vector (Step S404). The space characteristic vector generating unit 32 generates a vector (i.e. a space characteristic vector) by transforming spatial relationship in the objects in the object group into the vector (Step S405). The user attribute characteristic vector generating unit 33 generates a vector (i.e. a user attribute characteristic vector) by transforming a user attribute of the operation history into the vector (Step S406). The characteristic vector set generating unit 34 generates a characteristic vector set by transforming the vectors generated by the time characteristic vector generating unit 31, the space characteristic vector generating unit 32, and the user attribute characteristic vector generating unit 33 into the characteristic vector set (Step S407).

Next, the score calculating unit 42 of the recommend engine acquires the characteristic vector set generated by the characteristic vector set generating unit 34. The score calculating unit 42 acquires candidate operations from an operation group stored in advance in the data repository. The score calculating unit 42 calculates a score of each of the candidate operations (Step S409). In the present example, the score is a probability.

The recommend ranking determining unit 50 generates a recommend list as follows (Step S410). The recommend ranking determining unit 50 acquires the candidate operations and scores of the candidate operations from the score calculating unit 42. The recommend ranking determining unit 50 filters operations which is not able to be selected from the candidate operations. That is, the recommend ranking determining unit 50 eliminates operations which are not able to be selected from the candidate operations. The recommend ranking determining unit 50 sorts the remaining candidate operations are sorted in descending order of the scores. The recommend ranking determining unit 50 makes a recommend list in which the remaining candidate operations are sorted in descending order of the scores.

The recommend ranking determining unit 50 outputs the generated recommend list to a user (Step S411).

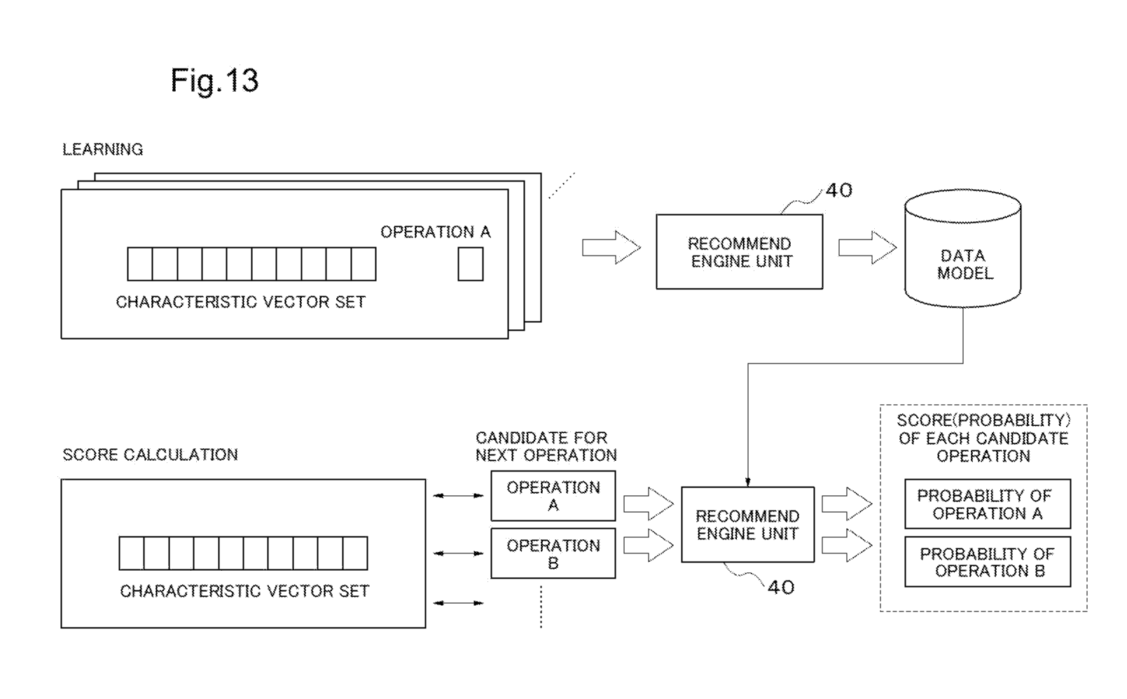

FIG. 13 is a diagram conceptually illustrating a data flow in learning and score calculation.

In the learning phase, a plurality of combinations of the characteristic vector set and the operations are supplied to the recommend engine unit 40. The recommend engine unit 40 outputs a data model.

In the score calculation (i.e. in the recommend phase), the data model, the characteristic vector set and a plurality of candidate operations are supplied to the recommend engine unit 40. The recommend engine unit 40 outputs a plurality of probabilities for the candidate operations.

### First Modification Example of the First Exemplary Embodiment

Next, a first modification example based on the first exemplary embodiment is explained in detail by referring to drawings.

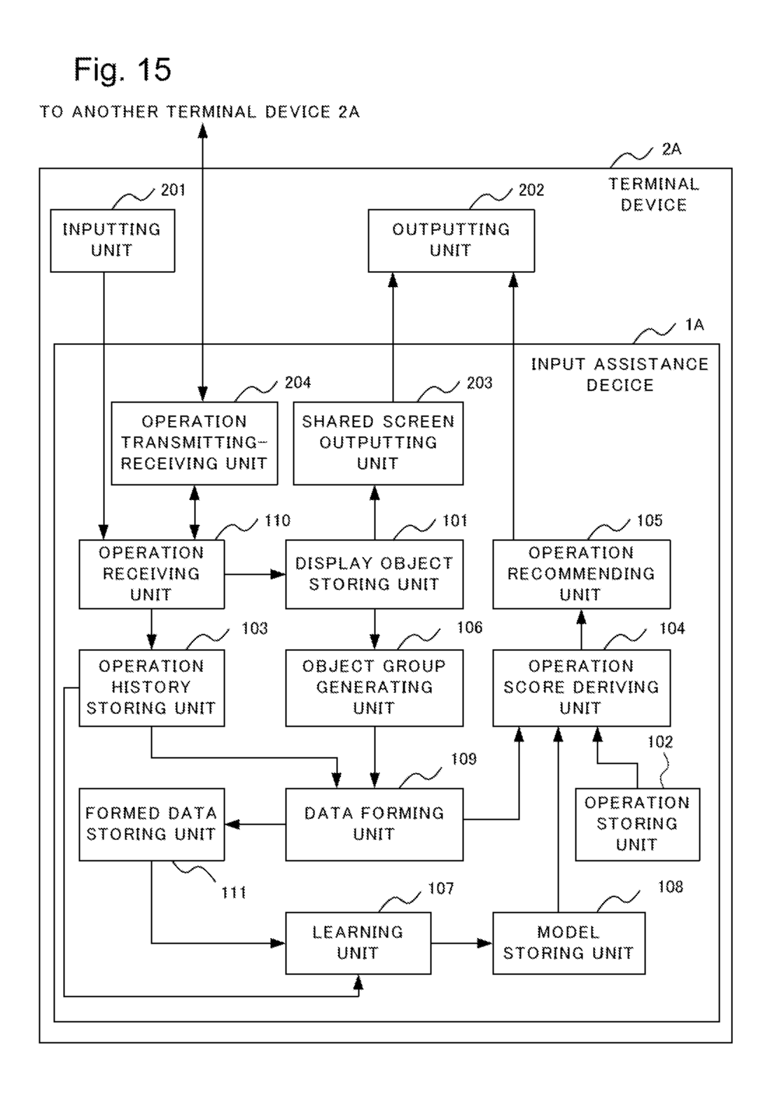

FIG. 15 is a block diagram illustrating a structure of a terminal device 2A of the first modification example of the first exemplary embodiment. With reference to FIG. 15, the terminal device 2A includes an input assistance device 1A.

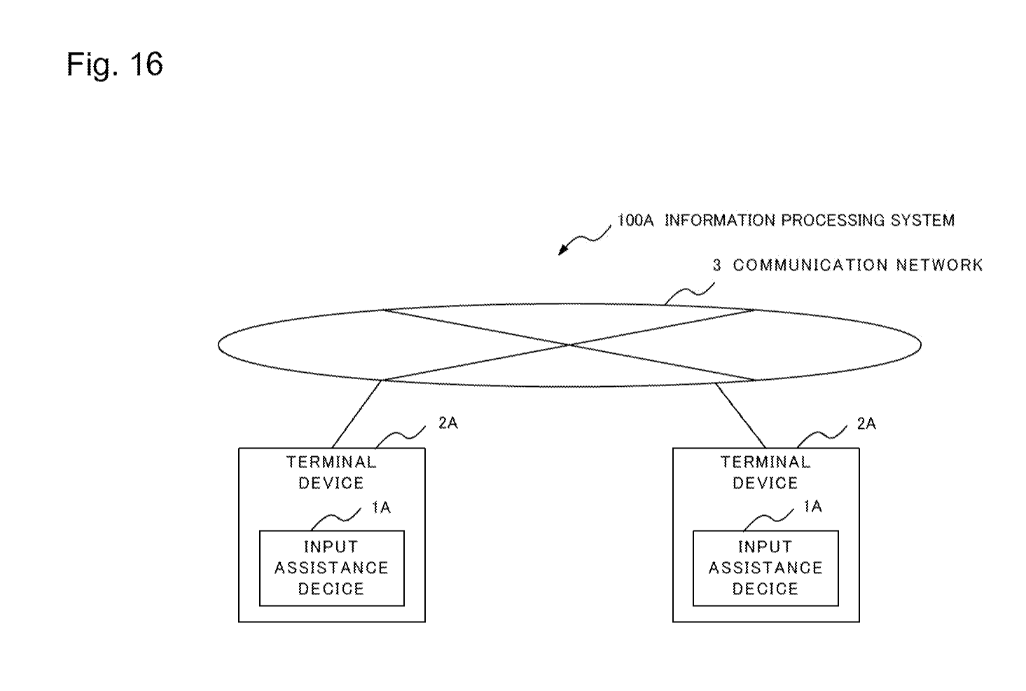

FIG. 16 is a block diagram illustrating a total image of an information processing system 100A of the present modification example. With reference to FIG. 16, the terminal devices 2A are communicably connected with one another through a communication network 3. The terminal devices 2A can communicate with each other.

The input assistance device 1A shown in FIG. 15 includes an operation transmitting-receiving unit 204 in addition to the elements of the input assistance device 1 shown in FIG. 2.

The operation transmitting-receiving unit 204 receives operation data of an operation performed by a user of another terminal device 2A from the terminal device 2, and transmits the operation data received from another terminal device 2A to the operation receiving unit 110. The operation transmitting-receiving unit 204 receives operation data of an operation performed by the user of the terminal device 2 including the operation transmitting-receiving unit 204. The operation transmitting-receiving unit 204 transmits the operation data of the operation performed by the user of the terminal device 2 including the operation transmitting-receiving unit 204 to other terminal devices 2A. The operation receiving unit 110 of the present modification example further transmits the operation data received from the inputting unit 201 to the operation transmitting-receiving unit 204.

The learning unit 107 of the present modification example may derive a model of the user of the terminal device 2A including the input assistance device 1A including the learning unit 107. The model storing unit 108 of the present modification example stores the derived model on the user of the terminal device 2A including the input assistance device 1A including the model storing unit 108. The operation score deriving unit 104 of the present modification example derives scores of operations and generates a list of operations for the user of the terminal device 2A including the input assistance device 1A. The operation recommending unit 105 of the present modification example outputs the list of operations to the outputting unit 202 of the terminal device 2A including the input assistance device 1A.

The information processing system 100A of the present modification example is the same as the information processing system 100 of the first exemplary embodiment in other parts thereof.

### Second Modification Example

Next a second modification example of the first exemplary embodiment is explained in detail with reference to drawings.

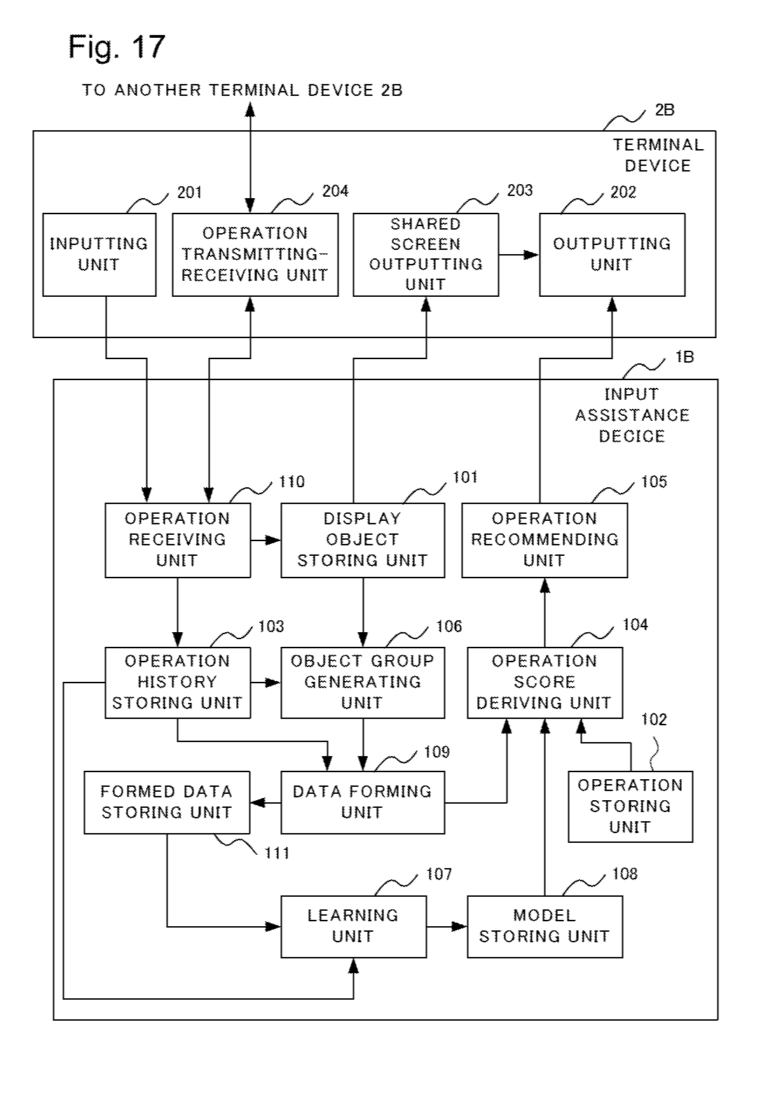

FIG. 17 is a block diagram illustrating an example of structures of an input assistance device 1B and a terminal device 2B of the present modification example. With reference to FIG. 17 in comparison with FIG. 15, the input assistance device 1B of the present modification example does not include the shared screen outputting unit 203 and the operation transmitting-receiving unit 204. The terminal device 2B of the present modification example includes the shared screen outputting unit 203 and the operation transmitting-receiving unit 204.

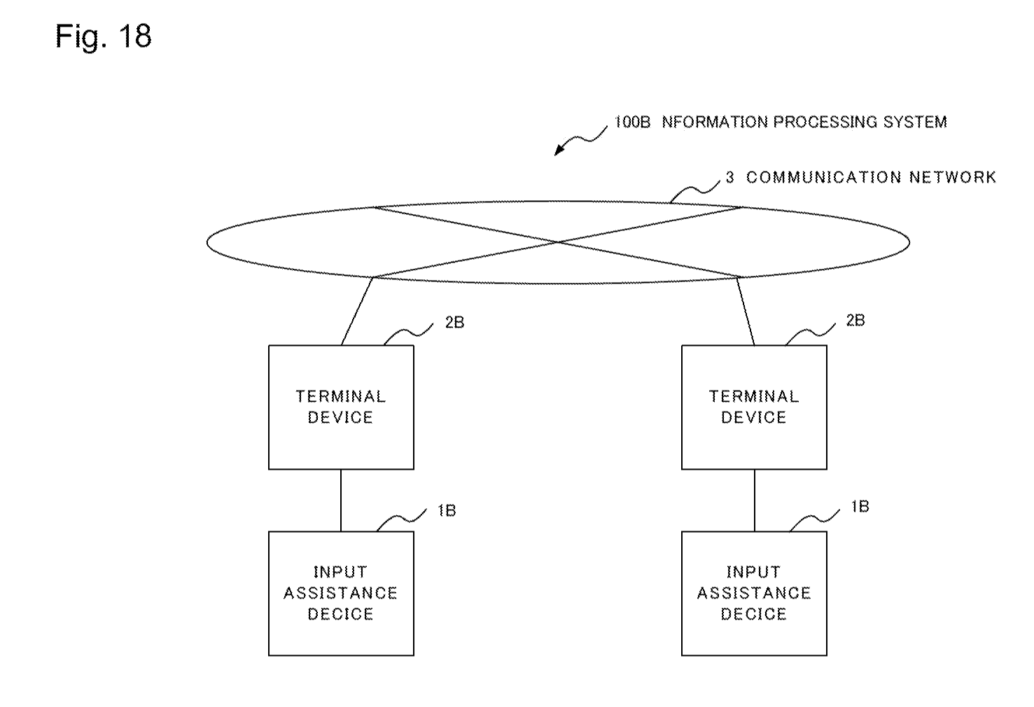

FIG. 18 is a block diagram conceptually illustrating a total image of the information processing system 100B of the present modification example. With reference to FIG. 18, the information processing system 100B of the present modification example include a plurality of terminal devices 2B, and an input assistance device 1B is connected with each of the terminal devices 2B. The terminal devices 2 connect with one another through the communication network 3.

The information processing system 100B of the present modification example is the same as the information processing system 100A of the first exemplary embodiment in other parts thereof.

### Second Exemplary Embodiment

A second exemplary embodiment of the present invention is described in detail with reference to drawings.

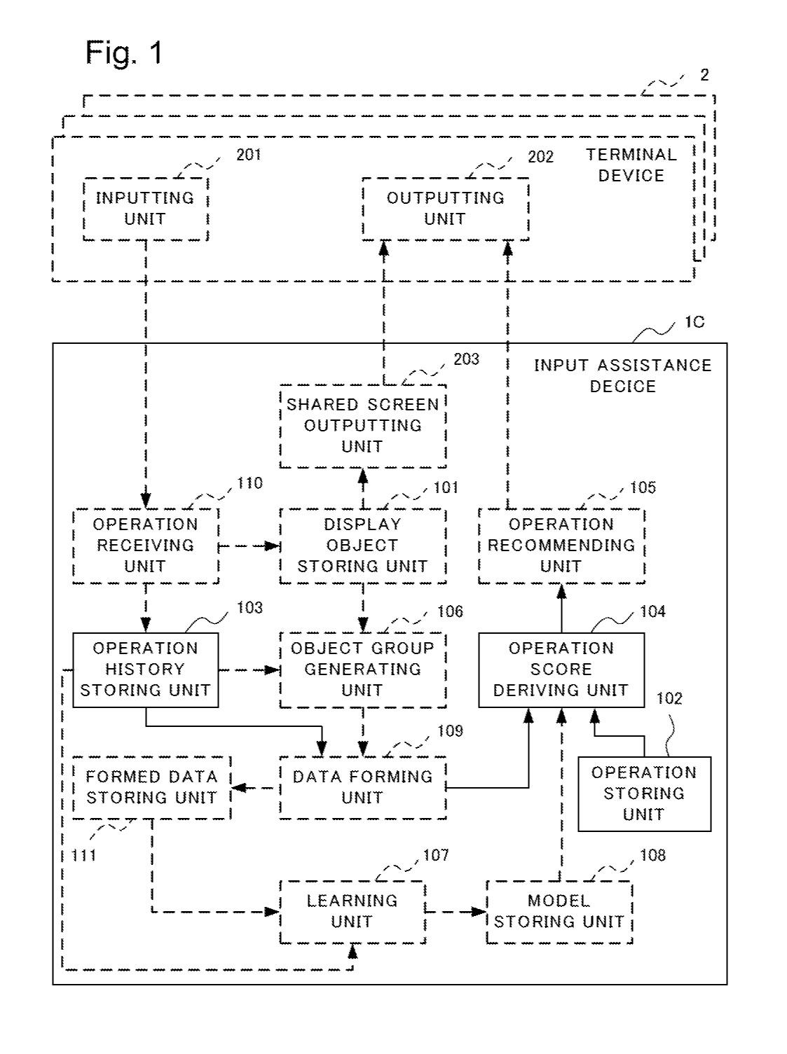

FIG. 1 is a block diagram illustrating a structure of an input assistance device 1C of the second exemplary embodiment.

With reference to FIG. 1, the input assistance device 1C of the exemplary embodiment includes the operation storing unit 102, the operation history storing unit 103, and the operation score deriving unit 104. The operation storing unit 102 stores a plurality of types of operations which target a display object arranged in a shared screen shared by a plurality of terminal devices 2. The operation history storing unit 103 stores a history operation which is an operation targeting an arranged object which is the display object stored in display object storing unit 101 and arranged in the shared screen, in order of performing the history operation. The operation storing unit 102 stores participating user identifiers which are identifiers of users of the plurality of terminal devices 2. The operation score deriving unit 104 derives operation probability which is probability that the target user next performs a candidate operation based on a target user identifier which is an identifier of the target user, the history operation, and the participating user identifiers. The target user is a user of the target terminal device in the plurality of terminal devices. The candidate operation is the operation stored in the operation storing unit 102.

The present exemplary embodiment explained above has the same effect as the first effect of the first exemplary embodiment. The reason is the same as the first reason of the first effect of the first exemplary embodiment.

The input assistance device 1, the input assistance device 1A, the input assistance device 1B, the input assistance device 1C, and the recommend server 1E is able to be implemented by a computer and a program controlling the computer, dedicated hardware, or a combination of the computer, the program controlling the computer, and the dedicated hardware.

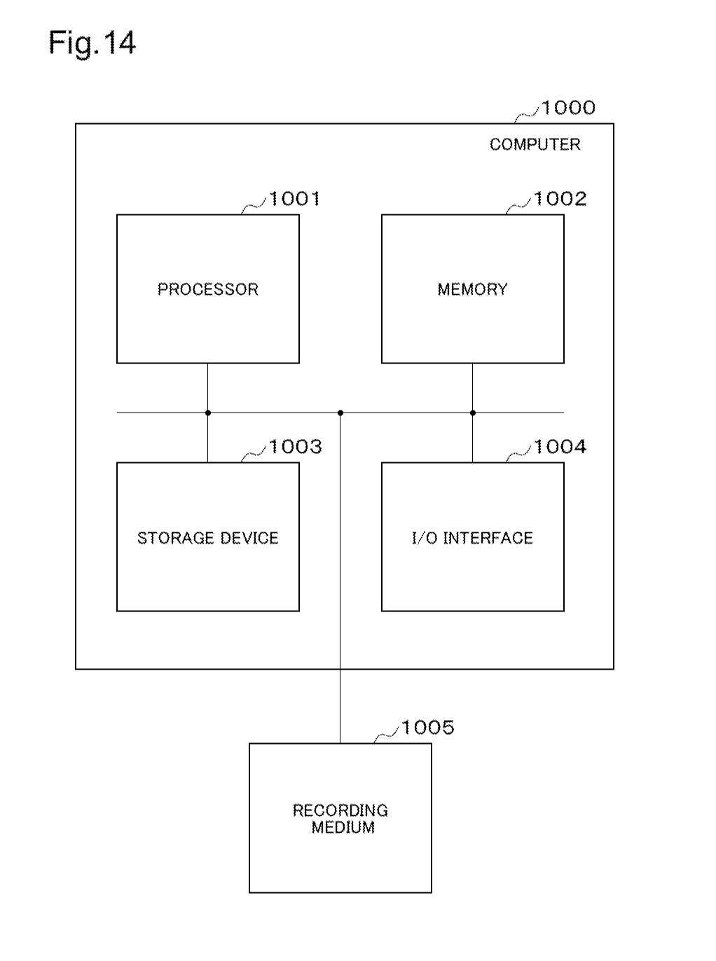

FIG. 14 is a diagram illustrating an example of a computer 1000 which is able to be used for implementing the input assistance device 1, the input assistance device 1A, the input assistance device 1B, the input assistance device 1C, and the recommend server 1E. With reference to FIG. 14, the computer 1000 includes a processor 1001, memory 1002, a storage device 1003, and an I/O (Input/Output) interface 1004. The computer 1000 can access a recording medium 1005. The memory 1002 and the storage device 1003 are storage devices, for example, a RAM (Random Access Memory), a hard disk. The recording medium 1005 is a storage device, like a RAM, a hard disc, ROM (Read Only Memory), a portable recording medium. The storage device 1003 may operate as the recording medium 1005. The processor 1001 can read and write data and a program from/to the memory 1002 and the storage device 1003. The processor 1001 can access, for example, the terminal device 2 through the I/O interface 1004. The processor 1001 can access the recording medium 1005. The recording medium 1005 stores a program causing a computer to perform as the input assistance device 1, the input assistance device 1A, the input assistance device 1B, the input assistance device 1C, or the recommend server 1E.

The processor 1001 loads the program, stored in the recording medium 1005, causing a computer 1000 to perform as the input assistance device 1, the input assistance device 1A, the input assistance device 1B, the input assistance device 1C, or the recommend server 1E, in the memory 1002. When the processor 1001 executes the program loaded in the memory 1002, the computer 1000 works, as the input assistance device 1, the input assistance device 1A, the input assistance device 1B, the input assistance device 1C, or the recommend server 1E.

The operation score deriving unit 104, the operation recommending unit 105, the object group generating unit 106, the learning unit 107, the data forming unit 109, the operation receiving unit 110, the shared screen outputting unit 203, the operation transmitting/receiving unit 204, the object group generating unit 10, the characteristic generating unit 30, the time characteristic vector generating unit 31, the space characteristic vector generating unit 32, and the user attribute characteristic vector generating unit 33, the characteristic vector set generating unit 34, the recommend engine unit 40, the learning unit 41, the score calculating unit 42, the recommend ranking determining unit 50, and the operation receiving unit 60 can be achieved by dedicated programs achieving functions of the elements, and which are read out from the recording medium 1005 and written into the memory 1002, and the processor 1001 performing the programs. The display object storing unit 101, the operation storing unit 102, the operation history storing unit 103, the model storing unit 108, the formed data storing unit 111, the data repository unit 20, the operation history data storing unit 21, and the object data storing unit 22 can be achieved by the storage device 1003, like the memory 1002, the hard disc device included in a computer. A part or all of the display object storing unit 101, the operation storing unit 102, the operation history storing unit 103, the operation score deriving unit 104, the operation recommending unit 105, the object group generating unit 106, the learning unit 107, the model storing unit 108, the data forming unit 109, the operation receiving unit 110, the formed data storing unit 111, the shared screen outputting unit 203, the operation transmitting/receiving unit 204, the object group generating unit 10, the data repository unit 20, the operation history data storing unit 21, and the object data storing unit 22, the characteristic generating unit 30, the time characteristic vector generating unit 31, the space characteristic vector generating unit 32, and the user attribute characteristic vector generating unit 33, the characteristic vector set generating unit 34, the recommend engine unit 40, the learning unit 41, the score calculating unit 42, the recommend ranking determining unit 50, and the operation receiving unit 60 can be achieved by dedicated circuits for achieving functions of the above elements.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A part or all of the above exemplary embodiments can be described as following supplemental notes, but is not limited thereto.

(Supplemental Note 1)

An input assistance device, including:

an operation storing unit which stores a plurality of types of operations targeting a display object arranged in a shared screen shared by a plurality of terminal devices;

an operation history storing unit which stores a history operation that is a performed operation targeting an arranged object that is the display object stored in display object storing unit and arranged in the shared screen, in order of performance of the history operation, and stores participating user identifiers that are identifiers of users of the plurality of terminal devices; and

an operation score deriving unit which derives an operation probability that is a probability that a target user who is a user of a target terminal device in the plurality of terminal devices performs next time a candidate operation that is the operation stored in the operation storing unit, based on a target user identifier that is an identifier of the target user, the history operation, and the participating user identifier.

(Supplemental Note 2)

The input assistance device according to supplemental note 1, wherein

the operation history storing unit stores an operating user identifier that is an identifier of the user performing the history operation, the operating user identifier being associated with the history operation, and

the operation score deriving unit derives the operation probability based on the target user identifier that is the identifier of the target user, the history operation, and the operating user identifier associated with the history operation.

(Supplemental Note 3)

The input assistance device according to supplemental note 1, wherein

the display object storing unit stores an arrangement position that is a position where the arranged object is arranged in the shared screen, the arrangement position being associated with the arranged object, and

the operation score deriving unit derives the operation probability based on the arrangement position.

(Supplemental Note 4)

The input assistance device according to supplemental note 1, wherein

the display object storing unit further stores an arrangement position that is a position where the arranged object is arranged in the shared screen, and a generation time when the arranged object is generated, the arrangement position and the generation time being associated with the arranged object,

the input assistance device further including:

an object group generating unit which generates, from the display object stored in the display object storing unit, an object group including at least a part of the display objects, so that difference in at least one of the arrangement position and the generation time between each of the display objects included in the object group and at least one of other display objects included in the object group satisfies a condition; and

a learning unit which deriving a parameter deriving the operation probability based on the history operation targeting the display object included in the object group, and

the operation score deriving unit derives the operation probability by using the derived parameter based on the history operation targeting the arranged object that is included in the object group including the arranged object targeted by a latest history operation.

(Supplemental Note 5)

The input assistance device according to supplemental note 4, wherein

the operation score deriving unit derives the operation probability based on the arrangement position.

(Supplemental Note 6)

The input assistance device according to supplemental note 1, wherein

the operation history storing unit stores an operation time when the operation on the arranged object is performed, the operation time being associated with the history operation, and

the operation probability deriving unit derives the operation probability based on the operation time.

(Supplemental Note 7)

The input assistance device of any one according to supplemental note 1, further including:

an operation receiving unit which receives the operation from the terminal device, updates the arranged object based on the received operation, and stores the received operation as the history operation in the operation history storing unit;

a shared screen outputting unit which outputs the shared screen in which the display object is arranged to the target terminal; and

an operation recommending unit which outputs information recommending inputting the candidate operation which is selected according to the derived operation probability of the candidate operation to the target terminal device.

(Supplemental Note 8)

An information processing system including the input assistance device of supplemental note 1, including:

the plurality of terminals.

(Supplemental Note 9)

An input assisting method, including:

storing a plurality of types of operations targeting a display object arranged in a shared screen shared by a plurality of terminal devices in operation storing unit;

storing a history operation that is a performed operation targeting an arranged object that is the display object stored in display object storing unit and arranged in the shared screen, in order of performance of the history operation, and storing participating user identifiers that are identifiers of users of the plurality of terminal devices in operation history storing unit; and

deriving an operation probability that is a probability that a target user who is a user of a target terminal device in the plurality of terminal devices performs next time a candidate operation that is the operation stored in the operation storing unit, based on a target user identifier that is an identifier of the target user, the history operation, and the participating user identifier.

(Supplemental Note 10)

The input assisting method according to supplemental note 9, including:

storing an operating user identifier that is an identifier of the user performing the history operation in the operation history storing unit, the operating user identifier being associated with the history operation, and

deriving the operation probability based on the target user identifier that is the identifier of the target user, the history operation, and the operating user identifier associated with the history operation.

(Supplemental Note 11)

The input assisting method according to supplemental note 9, including:

storing an arrangement position that is a position where the arranged object is arranged in the shared screen in the display object storing unit, the arrangement position being associated with the arranged object; and

deriving the operation probability based on the arrangement position.

(Supplemental Note 12)

The input assisting method according to supplemental note 9, including:

storing, in the display object storing unit, an arrangement position that is a position where the arranged object is arranged in the shared screen and a generation time when the arranged object is generated, the arrangement position and the generation time being associated with the arranged object;

generating, from the display object stored in the display object storing unit, an object group including at least a part of the display objects, so that difference in at least one of the arrangement position and the generation time between each of the display objects included in the object group and at least one of other display objects included in the object group satisfies a condition;

deriving a parameter deriving the operation probability based on the history operation targeting the display object included in the object group; and

deriving the operation probability by using the derived parameter based on the history operation targeting the arranged object that is included in the object group including the arranged object targeted by a latest history operation.

(Supplemental Note 13)

The input assisting method according to supplemental note 12, including:

deriving the operation probability based on the arrangement position.

(Supplemental Note 14)

The input assisting method according to supplemental note 9, including:

storing an operation time when the operation on the arranged object is performed, the operation time being associated with the history operation; and

deriving the operation probability based on the operation time.

(Supplemental Note 15)

The input assisting method according to supplemental note 9, including:

receiving the operation from the terminal device, updating the arranged object based on the received operation, and storing the received operation as the history operation in the operation history storing unit;

outputting the shared screen in which the display object is arranged to the target terminal; and

outputting information recommending inputting the candidate operation which is selected according to the derived operation probability of the candidate operation to the target terminal device.

(Supplemental Note 16)

A non-transitory computer-readable medium storing an input assistance program causing a computer to operate as:

an operation storing unit which stores a plurality of types of operations targeting a display object arranged in a shared screen shared by a plurality of terminal devices;

an operation history storing unit which stores a history operation that is a performed operation targeting an arranged object that is the display object stored in display object storing unit and arranged in the shared screen, in order of performance of the history operation, and stores participating user identifiers that are identifiers of users of the plurality of terminal devices; and

an operation score deriving unit which derives an operation probability that is a probability that a target user who is a user of a target terminal device in the plurality of terminal devices performs next time a candidate operation that is the operation stored in the operation storing unit, based on a target user identifier that is an identifier of the target user, the history operation, and the participating user identifier.

(Supplemental Note 17)

The non-transitory computer-readable medium according to supplemental note 16, storing the input assistance program causing a computer to operate as:

the operation history storing unit which stores an operating user identifier that is an identifier of the user performing the history operation, the operating user identifier being associated with the history operation; and

the operation score deriving unit which derives the operation probability based on the target user identifier that is the identifier of the target user, the history operation, and the operating user identifier associated with the history operation.

(Supplemental Note 18)

The non-transitory computer-readable medium according to supplemental note 16, storing the input assistance program causing a computer to operate as:

the display object storing unit which stores an arrangement position that is a position where the arranged object is arranged in the shared screen, the arrangement position being associated with the arranged object; and

the operation score deriving unit which derives the operation probability based on the arrangement position.

(Supplemental Note 19)

The non-transitory computer-readable according to supplemental note 16, storing the input assistance program causing a computer to operate as:

the display object storing unit which further stores an arrangement position that is a position where the arranged object is arranged in the shared screen, and a generation time when the arranged object is generated, the arrangement position and the generation time being associated with the arranged object;

an object group generating unit which generates, from the display object stored in the display object storing unit, an object group including at least a part of the display objects, so that difference in at least one of the arrangement position and the generation time between each of the display objects included in the object group and at least one of other display objects included in the object group satisfies a condition;

a learning unit which derives a parameter deriving the operation probability based on the history operation targeting the display object included in the object group; and

the operation score deriving unit which derives the operation probability by using the derived parameter based on the history operation targeting the arranged object that is included in the object group including the arranged object targeted by a latest history operation.

(Supplemental Note 20)

The non-transitory computer-readable medium having the input assistance program according to supplemental note 19, storing the input assistance program causing a computer to operate as:

the operation score deriving unit which derives the operation probability based on the arrangement position.

(Supplemental Note 21)

The non-transitory computer-readable medium according to supplemental note 16, storing the input assistance program causing a computer to operate as:

the operation history storing unit which stores an operation time when the operation on the arranged object is performed, the operation time being associated with the history operation; and

the operation probability deriving unit which derives the operation probability based on the operation time.

(Supplemental Note 22)

The non-transitory computer-readable medium according to supplemental note 16, storing the input assistance program causing a computer to operate as:

an operation receiving unit which receives the operation from the terminal device, updating the arranged object based on the operation, and storing the received operation as the history operation in the operation history storing unit;

a shared screen outputting unit which outputs the shared screen in which the display object is arranged to the target terminal; and

an operation recommending unit which outputs information recommending to input the candidate operation which is selected according to the derived operation probability of the candidate operation the target terminal device.

What is claimed is:

1. An input assistance device, comprising:
an operation storing unit which stores a plurality of types of operations targeting a display object arranged in a shared screen shared by a plurality of terminal devices;
an operation history storing unit which stores a history operation that is a performed operation targeting an arranged object which is the display object stored in display object storing unit and arranged in the shared screen, in order of performance of the history operation, and stores participating user identifiers that are identifiers of users of the plurality of terminal devices; and
an operation score deriving unit which derives an operation probability being a probability that a target user who is a user of a target terminal device in the plurality of terminal devices performs next time a candidate operation being the operation stored in the operation storing unit, based on a target user identifier being an identifier of the target user, the history operation, and the participating user identifier.

2. The input assistance device according to claim 1, wherein
the operation history storing unit stores an operating user identifier that is an identifier of the user performing the history operation, the operating user identifier being associated with the history operation, and
the operation score deriving unit derives the operation probability based on the target user identifier that is the identifier of the target user, the history operation, and the operating user identifier associated with the history operation.

3. The input assistance device according to claim 1, wherein
the display object storing unit stores an arrangement position that is a position where the arranged object is arranged in the shared screen, the arrangement position being associated with the arranged object, and
the operation score deriving unit derives the operation probability based on the arranging position.

4. The input assistance device according to claim 1, wherein
the display object storing unit further stores an arrangement position that is a position where the arranged object is arranged in the shared screen, and a generation time when the arranged object is generated, the arrangement position and the generation time being associated with the arranged object,
the input assistance device further comprises:
an object group generating unit which generates, from the display objects stored in the display object storing unit, an object group including at least a part of the display objects, so that difference in at least one of the arrangement position and the generation time between each of the display objects included in the object group and at least one of other display objects included in the object group satisfies a condition; and
a learning unit which derives a parameter to derive the operation probability based on the history operation targeting the display object included in the object group, and
the operation score deriving unit derives the operation probability by using the derived parameter based on the history operation targeting the arranged object that is included in the object group including the arranged object targeted by a latest history operation.

5. The input assistance device according to claim 4, wherein
the operation score deriving unit derives the operation probability based on the arranging position.

6. The input assistance device according to claim 1, wherein
the operation history storing unit stores an operation time when the history operation on the arranged object is performed, the operation time being associate with history operation, and
the operation probability deriving unit derives the operation probability based on the operation time.

7. The input assistance device according to claim 1, further comprising:
an operation receiving unit which receives the operation from the terminal device, updates the arranged object based on the received operation, and stores the received operation as the history operation in the operation history storing unit;
a shared screen outputting unit which outputs the shared screen in which the display object is arranged to the target terminal; and
an operation recommending unit which outputs information recommending inputting the candidate operation which is selected according to the derived operation probability of the candidate operation to the target terminal device.

8. An information processing system including the input assistance device according to claim 1, comprising:
the plurality of terminals.

9. An input assisting method, comprising:
storing a plurality of types of operations targeting a display object arranged in a shared screen shared by a plurality of terminal devices in operation storing unit;
storing a history operation that is a performed operation targeting an arranged object that is the display object stored in display object storing unit and arranged in the shared screen, in order of performance of the history operation, and storing participating user identifiers that are identifiers of users of the plurality of terminal devices in an operation history storing unit; and
deriving an operation probability being a probability that a target user who is a user of a target terminal device in the plurality of terminal devices performs next time a candidate operation being the operation stored in the operation storing unit, based on a target user identifier being an identifier of the target user, the history operation, and the participating user identifier.

10. A non-transitory computer-readable recording medium storing an input assistance program causing a computer to operate as:
operation storing unit which stores a plurality of types of operations targeting a display object arranged in a shared screen shared by a plurality of terminal devices;
operation history storing unit which stores a history operation that is a performed operation targeting an arranged object that is the display object stored in display object storing unit and arranged in the shared screen, in order of performance of the history operation, and for storing participating user identifiers that are identifiers of users of the plurality of terminal devices; and
operation score deriving unit which derives an operation probability being a probability that a target user who is a user of a target terminal device in the plurality of terminal devices performs next time a candidate operation being the operation stored in the operation storing unit, based on a target user identifier being an identifier of the target user, the history operation, and the participating user identifier.
